(19) United States
(12) Patent Application Publication
(10) Pub. No.: US 2026/0252174 A1
(43) Pub. Date: Aug. 27, 2026

(54) SIGNAL PROCESSING DEVICE, SIGNAL PROCESSING METHOD, AND PROGRAM

(71) Applicant: Sony Group Corporation, Tokyo (JP)

(72) Inventors: Hirofumi Takeda, Kanagawa (JP); Yasuhiro Toguri, Kanagawa (JP); Shuichiro Nishigori, Tokyo (JP)

(73) Assignee: Sony Group Corporation, Tokyo (JP)

(21) Appl. No.: 18/992,345

(22) PCT Filed: Jul. 7, 2023
(86) PCT No.: PCT/JP2023/025233

§ 371 Date: Jan. 8, 2025

(30) Foreign Application Priority Data
Jul. 19, 2022 (JP) 2022-114830

(51) Int. Cl. G06F 3/01

(52) U.S. Cl. CPC G06F 3/016

(57) ABSTRACT

A signal processing device in the present technology includes an interpolation signal generation unit that generates an interpolation signal based on a tactile signal in an adjacent section of a loss section and a physical model or a human perception model related to tactile sensation as an interpolation signal that interpolates a tactile signal lost during transmission.

### TECHNICAL FIELD

The present technology relates to a signal processing device that performs processing related to tactile signals, a method thereof, and a program, and particularly relates to a technique related to interpolation of a tactile signal lost during transmission.

### BACKGROUND ART

During these years, techniques are being developed in which a device worn by a user vibrates to give a tactile stimulus to the user. Here, a tactile stimulus refers to a physical phenomenon that causes the user to feel a tactile sensation through a vibration phenomenon or the like. Generating a tactile stimulus will be referred to as “tactile presentation” hereinafter.

Techniques for performing tactile presentation are used in devices in various fields. For example, in a terminal device including a touch panel, such as a smartphone, the touch panel vibrates in response to a touch operation from a user and gives a tactile stimulus to the user's finger, so that a touch feeling on a button or the like displayed on the touch panel can be expressed. Furthermore, in a music listening device such as headphones, for example, it is possible to emphasize a heavy bass in music that is being played back by giving a tactile stimulus in accordance with the playback of the music. Furthermore, in a device that provides a computer game, virtual reality (VR), or the like, for example, it is possible to improve a user's sense of immersion in the content by vibrating a controller or the like to give a tactile stimulus in accordance with an operation using the controller or a content scene.

Furthermore, techniques for giving a tactile stimulus to a user on the basis of a tactile signal received from an external device are being developed. For example, Patent Document 1 below discloses a technique for giving a tactile stimulus to a user while changing frequency and amplitude of vibration on the basis of a received signal.

Here, since tactile presentation devices are generally brought into contact with a body of a user, wired connection between various devices is likely to hinder user experience, and handling becomes more complicated in a case where the tactile presentation devices are multi-channeled. It is therefore desirable to establish a wireless connection between a device that obtains or generates a tactile signal and a device that ultimately presents the tactile signal to a user.

In a case where signals are transmitted using a wireless connection, on the other hand, a good communication environment is not always achieved, and a loss of a transmission signal, such as a packet loss, cannot be avoided.

Many countermeasures are considered for transmission of audio signals. For example, there is a measure for providing a retransmission margin at a time of a packet loss by enlarging a communication buffer. As a result, since a time margin is generated until a signal in a section corresponding to a lost signal is reproduced, it is possible to recover from a packet loss by successfully performing retransmission by that time.

Furthermore, packet loss concealment is also known in which a loss of an original signal is concealed so that a use does not perceive the loss. As a representative method, a loss section is filled with noise or a sine wave, or a last frame is copied or extended to be substituted for a lost signal.

It is not appropriate, however, to directly use the measures for audio signals as described above for tactile signals.

Since the method in which a communication buffer is enlarged is intended to extend a time from reception to playback, it is difficult to simultaneously achieve a low delay, which is important as a quality of tactile experience.

Furthermore, since the packet loss concealment for audio signals has been constructed as a technique that provides excellent concealment for hearing in consideration of human auditory characteristics, there is no guarantee that a packet loss can be well concealed in a tactile sensation.

Note that Patent Documents 2 and 3 below can be cited as related examples of the background art.

Patent Document 2 proposes adjustment of signal length through insertion and removal of zero sections into and from a signal, and by using this, a conventional method of packet loss concealment for audio can be performed.

Furthermore, Patent Document 3 proposes that in a case where a signal transmitted to a vibration output device has been lost, the signal is retransmitted to ensure reproduction of the original signal. This, however, causes a problem of a delay in tactile experience.

### CITATION LIST

### Patent Document

Patent Document 1: Japanese Patent Application Laid-Open No. 2016-202486
Patent Document 2: Japanese Patent Application Laid-Open No. 2020-85033
Patent Document 3: Japanese Patent Application Laid-Open No. 2020-116256

### SUMMARY OF THE INVENTION

### Problems to be Solved by the Invention

The present technology has been made in view of the above circumstances, and an object thereof is to provide a signal interpolation method that makes it difficult for a user to notice a loss of a tactile signal, and to improve the user's sense of immersion in tactile content.

### Solutions to Problems

A first signal processing device in the present technology includes an interpolation signal generation unit that generates an interpolation signal based on a tactile signal in an adjacent section of a loss section and a physical model or a human perception model related to tactile sensation as an interpolation signal that interpolates a tactile signal lost during transmission.

As a result, an interpolation signal based on characteristics related to tactile sensation is generated as the interpolation signal for the loss section of the tactile signal.

Furthermore, a second signal processing device in the present technology includes an interpolation method selection unit that selects an interpolation method for interpolating a tactile signal lost during transmission on the basis of a result of performing, as a signal analysis of the tactile signal, a signal analysis based on a physical model or a human perception model related to tactile sensation and an interpolation method setting unit that performs processing for generating transmission data in which additional information indicating the interpolation method selected by the interpolation method selection unit is added to the tactile signal as transmission data of the tactile signal.

With the above configuration, interpolation processing for interpolating a tactile signal lost during transmission can be performed by an appropriate method selected on the basis of a physical model or a human perception model related to tactile sensation.

### BRIEF DESCRIPTION OF DRAWINGS

FIG. 1 is a block diagram illustrating a configuration example of a tactile presentation system as a first embodiment of the present technology.

FIG. 2 is a block diagram for describing an internal configuration example of a transmission device included in a tactile presentation system as the first embodiment.

FIG. 3 is a diagram illustrating an example of data structure of transmission data of a tactile signal according to the first embodiment.

FIG. 4 is a block diagram illustrating an internal configuration example of a reception device and a tactile presentation device included in the tactile presentation system as the first embodiment.

FIG. 5 is an explanatory diagram of an interpolation signal generation method as the first embodiment.

FIG. 6 is a flowchart illustrating an example of a processing procedure for achieving the interpolation signal generation method as the first embodiment.

FIG. 7 is a block diagram illustrating an internal configuration example of a reception device as a second embodiment.

FIG. 8 is an explanatory diagram of an interpolation signal generation method as the second embodiment.

FIG. 9 is a flowchart illustrating an example of a processing procedure for achieving the interpolation signal generation method as the second embodiment.

FIG. 10 is a block diagram illustrating a configuration example of a tactile presentation system as a third embodiment.

FIG. 11 is a block diagram illustrating an internal configuration example of a tactile presentation device and a presentation control device according to the third embodiment.

FIG. 12 is an explanatory diagram of an interpolation signal generation method as the third embodiment.

FIG. 13 is a flowchart illustrating an example of a processing procedure for achieving the interpolation signal generation method as the third embodiment.

FIG. 14 is a block diagram for describing an internal configuration example of a transmission device as a fourth embodiment.

FIG. 15 is a diagram illustrating an example of data structure of packet data according to the fourth embodiment.

FIG. 16 is a block diagram for describing an internal configuration example of a reception device as the fourth embodiment.

FIG. 17 is a flowchart illustrating an example of a processing procedure for achieving functions of the transmission device as the fourth embodiment.

FIG. 18 is a flowchart illustrating an example of a processing procedure for achieving functions of the reception device as the fourth embodiment.

### MODE FOR CARRYING OUT THE INVENTION

Embodiments according to the present technology will be described hereinafter in the following order with reference to the accompanying drawings.

### 1. First Embodiment

[1-1. Outline of Tactile Presentation System]
[1-2. Transmission Device]
[1-3. Reception Device]
[1-4. Interpolation Signal Generation Method as First Embodiment]
[1-5. Processing Procedure]
<2. Second Embodiment
<3. Third Embodiment
<4. Fourth Embodiment
<5. Modifications>
<6. Summary of Embodiments>
<7. Present Technology>

Here, individual terms are defined as follows in the present specification.

Tactile stimulus: a physical phenomenon that causes a person to perceive a tactile sensation such as a vibration phenomenon.

Tactile presentation: generation of a tactile stimulus.

Tactile information: information perceived as a tactile sensation such as vibration information.

Tactile signal: a signal that represents a tactile stimulus pattern such as a signal that represents a vibration waveform.

Recipient: a person who receives tactile presentation.

Coded data: data obtained by encoding a signal.

Examples of a more specific concept include data obtained by performing compression encoding or uncompressed encoding (lossless) on a signal.

### 1. First Embodiment

### [1-1. Outline of Tactile Presentation System]

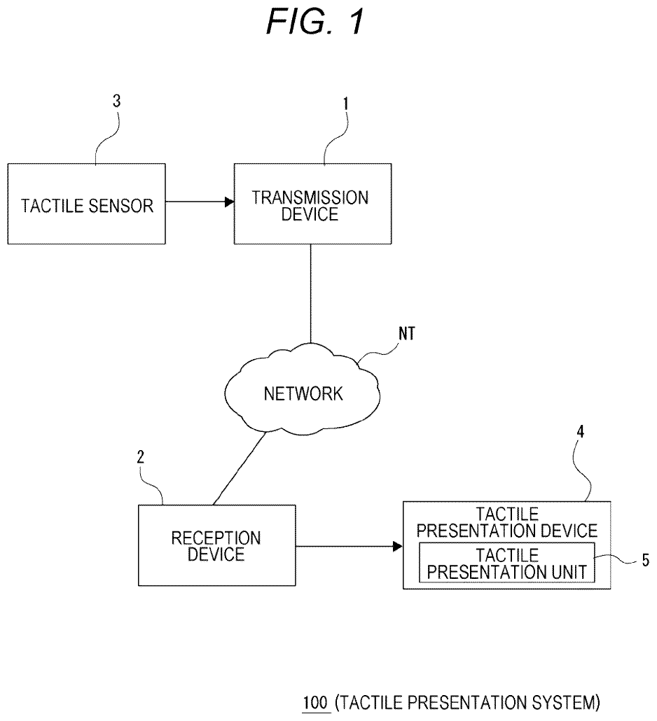

FIG. 1 is a block diagram illustrating a configuration example of a tactile presentation system 100 as a first embodiment of the present technology.

A tactile presentation system 100 according to the present embodiment senses target tactile information (tactile stimulus) to obtain a tactile signal, transmits the tactile signal to a destination device via a predetermined communication path, and performs tactile presentation to a user as a recipient using a tactile presentation device provided at a destination.

As illustrated, the tactile presentation system 100 includes a transmission device 1, a reception device 2, a tactile sensor 3, and a tactile presentation device 4.

The tactile sensor 3 is a sensor that senses tactile information, and in the present example, a vibration sensor such as an acceleration sensor or a piezo pickup is used. The tactile sensor 3 is brought into contact with an object to be sensed, that is, a human body in the present example, to output vibration or motion as a voltage change.

In the present example, the tactile sensor 3 is connected to the transmission device 1 in a wired manner, and the tactile sensor 3 is attached to a predetermined part of a human body as an object and senses tactile information corresponding to a tactile stimulus generated at the part.

The transmission device 1 includes a computer device such as a central processing unit (CPU) or a digital signal processor (DSP), for example, and performs processing for encoding a detection signal (tactile signal) using the tactile sensor 3 in a predetermined data format and transmitting coded data to the reception device 2 over a network NI, which is a communication network such as the Internet or a local area network (LAN). As described later, the coded data of the tactile signal is packetized and transmitted to the network NT.

The reception device 2 includes a computer device such as a CPU or a DSP, decodes coded data received from the transmission device 1 over the network NT, and outputs a tactile signal obtained as a result of the decoding to the tactile presentation device 4.

The tactile presentation device 4 includes a tactile presentation unit 5, and presents a tactile stimulus based on a tactile signal input from the reception device 2 to a user as a recipient. The tactile presentation unit 5 is a device that generates a tactile stimulus, and in the present example, a vibrating device such as a vibrator or an actuator is used.

Note that, as another example of the tactile presentation unit 5, it is also conceivable to employ a mode of a device that outputs focused ultrasound waves or balls of air using a speaker array, a mode of a pressure presentation device by controlling the amount of fluid in the device, or a mode of an electrical stimulation device that directly stimulates a tactile receptor using electricity. In the case of any of these modes, vibration can be perceived by a human body.

Note that an example in which the transmission device 1 transmits a tactile signal to the reception device 2 over the network NT has been described here, but the transmission of a tactile signal from the transmission device 1 to the reception device 2 may be performed through short-range wireless communication such as Bluetooth (registered trademark), instead.

Furthermore, although only a tactile signal has been mentioned here, it is also possible to record an audio signal or a video signal synchronized with a tactile signal together with the tactile signal and provide a sound or a video for a recipient together with tactile information, instead.

### 1-2. Transmission Device

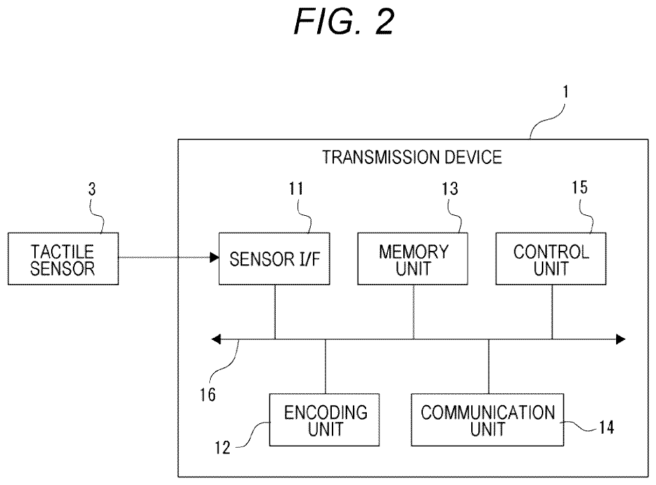

FIG. 2 is a block diagram for describing an internal configuration example of the transmission device 1, and illustrates the tactile sensor 3 illustrated in FIG. 1 together with the internal configuration example of the transmission device 1.

The transmission device 1 includes a sensor interface (I/F) 11, an encoding unit 12, a memory unit 13, a communication unit 14, and a control unit 15. As illustrated in the drawing, these units are connected to a bus 16, and can perform data communication via the bus 16.

The sensor I/F 11 is a communication interface unit for the tactile sensor 3, and receives a tactile signal obtained by the tactile sensor 3.

The encoding unit 12 includes, for example, a DSP, and encodes a tactile signal input from the tactile sensor 3 via the sensor I/F 11. As this encoding method, one of various methods generally used to encode audio signals, which are one-dimensional signals like tactile signals, can be employed. For example, MPEG-1 Audio Layer-III (MP3), Advanced Audio Coding (AAC), or the like may be used, or Free Lossless Audio Codec (FLAC), which is a lossless encoding method, may be used. Furthermore, it is also conceivable to employ Adaptive Differential Pulse Code Modulation (ADPCM) or the like in consideration of operation resources.

In the encoding unit 12, the tactile signal is divided in units of frames having a certain length, and encoding is performed for each frame.

A frame of a tactile signal will be referred to as a “frame Fr” hereinafter.

The memory unit 13 comprehensively represents a storage device such as a hard disk drive (HDD) or a solid state drive (SSD), for example, and is used to store various types of data in the transmission device 1. For example, the memory unit 13 stores data necessary for control by the control unit 15. Furthermore, coded data obtained by the encoding unit 12 can be stored in the memory unit 13 under the control of the control unit 15.

The communication unit 14 performs data communication with external devices. More specifically, the communication unit 14 in the present example has a network communication function, and can perform data communication with the reception device 2 over the network NT illustrated in FIG. 1.

The control unit 15 is provided with a microcomputer including a CPU, a read only memory (ROM), a random access memory (RAM), and the like, for example, and the CPU performs processing according to a program stored in the ROM to control the entirety of the transmission device 1.

For example, the control unit 15 performs data communication with external devices, in particular, the reception device 2, via the communication unit 14. More specifically, the control unit 15 performs processing for transmitting coded data of a tactile signal obtained by the encoding unit 12 to the reception device 2. In the present example, the control unit 15 packetizes coded data of a tactile signal and transmits the packetized data to the reception device 2.

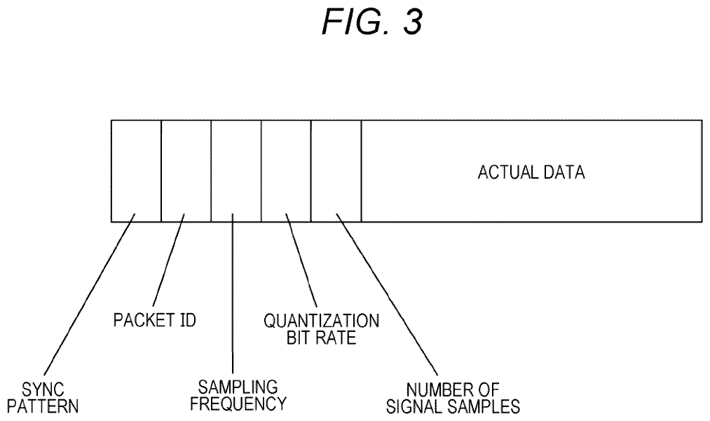

FIG. 3 is a diagram illustrating an example of data structure of packet data in the present example.

In the present example, the control unit 15 generates packet data (transmission data) illustrated in FIG. 3 on the basis of coded data of a tactile signal.

Here, in the present example, packetization is performed for each frame Fr of the tactile signal. That is, each piece of packet data includes a tactile signal of one frame Fr.

As illustrated in the drawing, information of a sync pattern, a packet ID, a sampling frequency, a quantization bit rate, and the number of signal samples is added in the packet data in this case for actual data of the tactile signal.

The sync pattern is an identifier indicating a head of the packet data, and data in a predetermined bit pattern is stored. It is conceivable that, for example, 16 bits are allocated to the sync pattern and a predetermined bit pattern such as 0xFFFE is used.

The packet ID indicates an ID of the packet data. The control unit 15 assigns, for example, sequential numbers in ascending order as the packet ID. More specifically, sequential numbers in ascending order are assigned in chronological order of tactile signals.

The sampling frequency and the quantization bit number indicate a sampling frequency and a quantization bit rate at a time of digital sampling of the tactile signal, respectively.

The number of signal samples indicates the number of samples of the tactile signal as the actual data stored in the packet data, or more specifically, the number of samples in units of frames Fr in the present example.

In FIG. 2, the control unit 15 generates the above-described packet data on the basis of coded data of a tactile signal, and performs processing in such a way as to transmit the packet data to the reception device 2 via the communication unit 14.

### [1-3. Reception Device]

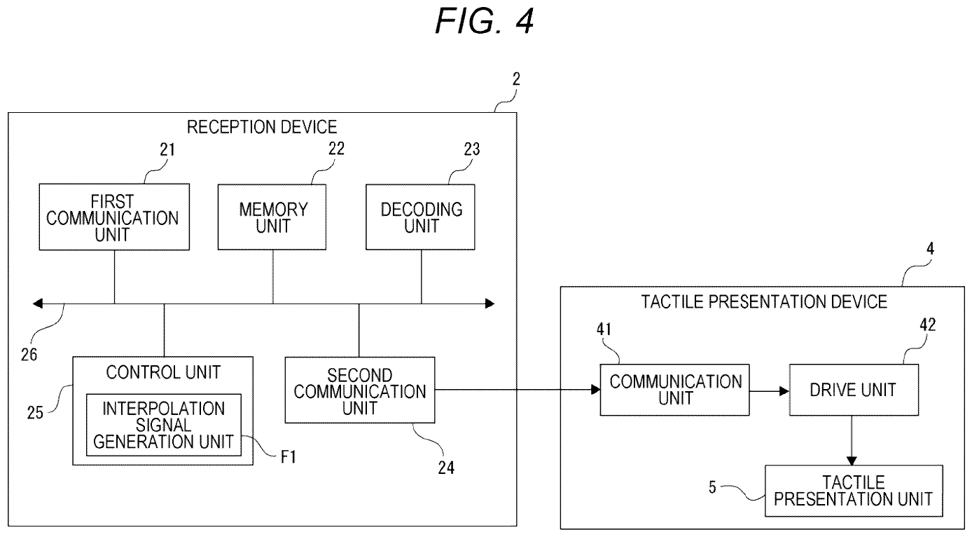

FIG. 4 is a block diagram illustrating an internal configuration example of the reception device 2 and the tactile presentation device 4.

As illustrated, the reception device 2 includes a first communication unit 21, a memory unit 22, a decoding unit 23, a second communication unit 24, and a control unit 25, and these units are connected to a bus 26 and can perform data communication via the bus 26.

Furthermore, the tactile presentation device 4 includes a communication unit 41 and a drive unit 42 together with the tactile presentation unit 5 described above.

In the reception device 2, the first communication unit 21 performs data communication with external devices, or more specifically, has a network communication function in the present example and can perform data communication with the transmission device 1 (communication unit 14) over the network NT illustrated in FIG. 1.

The memory unit 22 comprehensively represents a storage device such as an HDD or an SSD, and is used to store various types of data in the reception device 2. For example, the memory unit 22 stores data necessary for control by the control unit 25. Furthermore, packet data received from the transmission device 1 via the first communication unit 21 and decoded data (decoded data of coded data) obtained by the decoding unit 23 can be stored in the memory unit 22 under the control of the control unit 25.

The decoding unit 23 decodes coded data (coded data of a tactile signal) included in packet data received from the transmission device 1 via the first communication unit 21 to obtain the tactile signal.

The second communication unit 24 performs communication processing for outputting a decoded tactile signal to the tactile presentation device 4. Note that a connection between the reception device 2 and the tactile presentation device 4 for this communication may be a wired connection or a wireless connection.

In the tactile presentation device 4, a tactile signal output from the reception device 2 via the second communication unit 24 is input via the communication unit 41, and the drive unit 42 drives the tactile presentation unit 5 on the basis of the input tactile signal.

As a result, it is possible to perform tactile presentation corresponding to tactile information sensed by the tactile sensor 3 illustrated in FIG. 1 to a user as a recipient wearing the tactile presentation device 4.

In the reception device 2, the control unit 25 includes, for example, a microcomputer including a CPU, a ROM, a RAM, and the like, and the CPU performs processing according to a program stored in the ROM to control the entirety of the reception device 2.

For example, the control unit 25 causes the decoding unit 23 to perform decoding processing on coded data included in packet data received from the transmission device 1 via the first communication unit 21. Furthermore, the control unit 25 performs processing for causing the second communication unit 24 to output a tactile signal decoded by the decoding unit 23 to the tactile presentation device 4 as processing for outputting a tactile signal.

Furthermore, the control unit 25 has a function as an interpolation signal generation unit F1 as a function according to the embodiment.

The interpolation signal generation unit F1 generates, as an interpolation signal that interpolates a tactile signal lost during transmission, an interpolation signal based on a tactile signal in an adjacent section of a loss section and a physical model or a human perception model related to tactile sensation.

### [1-4. Interpolation Signal Generation Method as First Embodiment]

The function as the interpolation signal generation unit F1 will be described hereinafter.

In the first embodiment, as the generation of an interpolation signal, an interpolation signal based on a physical model related to a tactile sensation is generated. More specifically, an interpolation signal based on a damped sine wave model is generated.

A damped sine wave is frequently observed in a tactile signal as a vibration waveform due to, for example, a collision or a slip between objects.

By generating an interpolation signal based on the damped sine wave model, therefore, it is possible to make it difficult for the user to notice a loss of a tactile signal, and it is possible to improve the user's sense of immersion in tactile content.

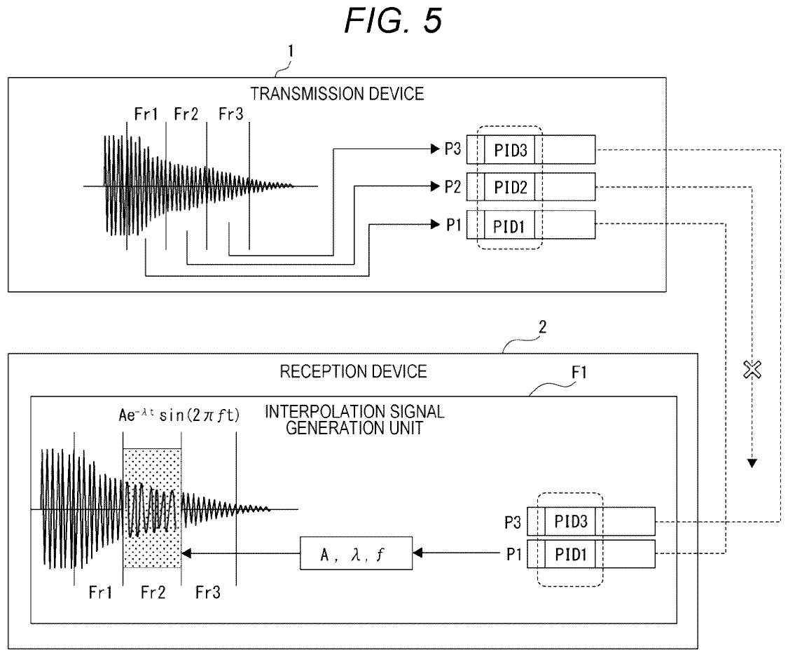

FIG. 5 is an explanatory diagram of an interpolation signal generation method as the first embodiment.

First, as illustrated in an upper part of the drawing, a tactile signal is packetized on a transmission device 1 side in units of frames Fr, and packet data is transmitted to a reception device 2 side. In the drawing, three consecutive frames Fr in the tactile signal are defined as frames Fr1, Fr2, and Fr3, and packet data obtained by packetizing the frames Fr1, Fr2, and Fr3 are defined as packets P1, P2, and P3.

As described above, a packet ID for identifying each packet is attached to packet data, and in the drawing, packet IDs attached to the packets P1, P2, and P3 are denoted as PID1, PID2, and PID3.

Here, it is assumed that the packet P2 among the packets P1, P2, and P3 has been lost in a process of transmission to the reception device 2. On the reception device 2 side, the control unit 25 performs packet data loss determination processing on the basis of information regarding packet IDs of received packet data. More specifically, it is determined whether a packet ID is missing.

In the case of FIG. 5, since it is determined that PID2 is missing, a determination result indicating that the packet P2 has been lost is obtained.

In the first embodiment, in response to detection of such a loss of a tactile signal, an interpolation signal for interpolating (concealing) a loss section is generated on the basis of a tactile signal in an adjacent section of the loss section (lost packet) and a damped sine wave model expressed by the following [Expression 1].

$$\begin{matrix}[ Math . 1 ] & \\ {Ae}^{- λ t} sin ( 2 π ft ) & [ Expression 1 ]\end{matrix}$$

In [Expression 1], t denotes time, A denotes initial amplitude of a signal, λ denotes a damping coefficient, and f denotes frequency of the signal. Note that e means exponential.

More specifically, in the generation of an interpolation signal in this case, first, the initial amplitude A, the envelope waveform (damping coefficient) λ for each time t, and the frequency f of a tactile signal for three frames including the frame Fr (frame Fr2) of the lost packet and preceding and following frames (frames Fr1 and Fr3) are obtained by a known waveform analysis method on the basis of the tactile signal of a packet (packet P1 in the example in the drawing) immediately before the lost packet and a packet (packet P3) immediately after the lost packet. As the initial amplitude A, an initial amplitude of the frame Fr (frame Fr1) immediately before the lost frame Fr is used. At this time, the envelope waveform λ for each time t can be obtained by a known envelope calculation method such as the Hilbert transform. Furthermore, the frequency f for each time t can be obtained by, for example, a known envelope calculation method using a peak position of an autocorrelation function or the like.

As described above, the initial amplitude A, the waveform envelope (damping coefficient) λ for each time t, and the frequency f of the tactile signal for three frames are obtained, and then a damped sine wave is generated using these values in [Expression 1]. In the signal generated as the damped sine wave in this manner, a signal in a section corresponding to the lost frame Fr (frame Fr2) is obtained as an interpolation signal.

If determining that a packet has been lost, the control unit 25 performs processing for outputting the interpolation signal generated as described above to the tactile presentation device 4 as the tactile signal of the loss section (the signal section of the frame Fr2).

As a result, it is possible to reduce a delay of tactile experience as compared with a case of retransmitting a lost packet, to make it difficult for the user to notice the loss of the tactile signal, and to improve the user's sense of immersion in tactile content.

### [1-5. Processing Procedure]

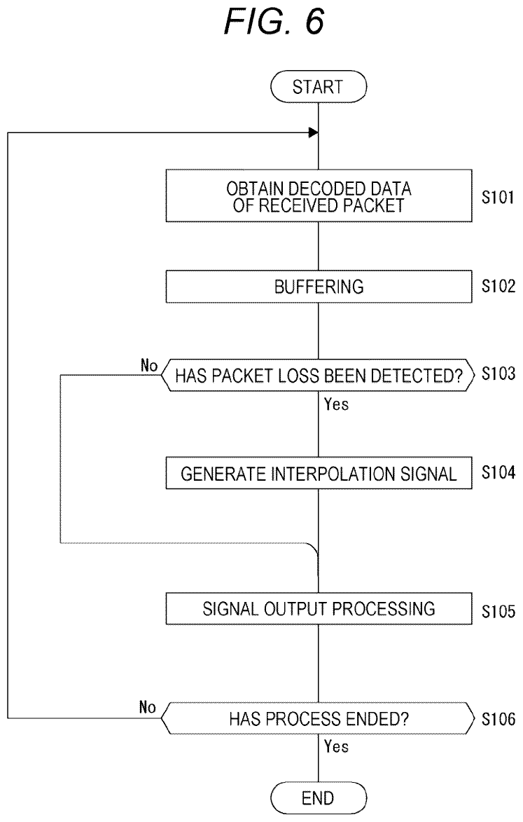

FIG. 6 is a flowchart illustrating an example of a processing procedure for achieving the interpolation signal generation method as the first embodiment described above.

Note that, in the present example, the control unit 25 illustrated in FIG. 4 performs a process illustrated in FIG. 6. More specifically, the CPU in the control unit 25 performs the process on the basis of a program stored in a predetermined storage device, such as the ROM, of the control unit 25.

In FIG. 6, the control unit 25 first performs processing for obtaining decoded data of a received packet in step S101. That is, the decoding unit 23 is caused to perform decoding processing on coded data included in packet data received from the transmission device 1 via the first communication unit 21, and a tactile signal (a tactile signal for one frame in this example) obtained through the decoding processing is obtained.

In step S102 subsequent to step S101, the control unit 25 performs processing for buffering the obtained decoded data. This buffering is performed in such a way as to hold three consecutive frames Fr required for generating an interpolation signal. More specifically, assuming that the most recently received frame Fr is a frame Fr3, three frames Fr1, Fr2, and Fr3 are held.

In step S103 subsequent to step S102, the control unit 25 determines whether or not a packet loss has been detected. As described above, the determination as to a packet loss is performed as a determination as to whether or not a packet ID attached to packet data has been lost. In this case, whether or not a packet has been lost cannot be determined unless a next frame Fr of the frame Fr targeted for the loss determination is received.

If it is determined in step S103 that packet loss has been detected, the control unit 25 advances the process to step S104 and performs interpolation signal generation processing. Note that the interpolation signal generation method as the first embodiment, that is, the interpolation signal generation method based on the damped sine wave model, has already been described, and redundant description thereof is avoided.

Then, the control unit 25 advances the process to step S105 in response to the execution of the interpolation signal generation processing in step S104.

If it is determined in step S103 that a packet loss has not been detected, on the other hand, the control unit 25 passes the interpolation signal generation processing in step S104 and advances the process to step S105.

In step S105, the control unit 25 performs signal output processing. In this signal output processing, a tactile signal corresponding to a section of a frame Fr immediately before the most recently received frame Fr is output to the tactile presentation device 4. More specifically, if it is determined in step S103 that a packet loss has not been detected, the tactile signal of the frame Fr immediately before the most recently received frame Fr (that is, the tactile signal received without a loss) is output, and if it is determined in step S103 that a packet loss has been detected, an interpolation signal generated for the frame Fr immediately before the most recently received frame Fr is output.

In step S106 subsequent to step S105, the control unit 25 determines whether or not the process has ended, that is, whether or not a predetermined process end condition has been satisfied (for example, an instruction to stop the tactile presentation to the user has been issued, the tactile presentation device 4 has been disconnected, the reception device 2 has been powered off, or the like).

If it is determined in step S106 that the process has not ended, the control unit 25 returns to step S101. As a result, a determination as to a packet loss and interpolation signal generation in a case where a packet loss has been detected are performed for a next packet.

If it is determined in step S106 that the process has ended, on the other hand, the control unit 25 ends the process illustrated in FIG. 6.

### 2. Second Embodiment

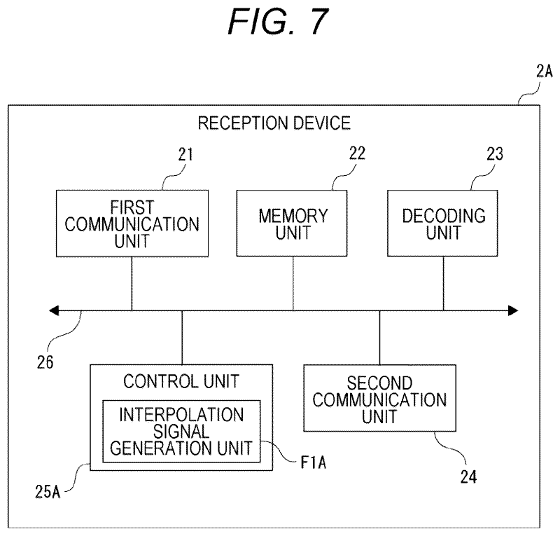

FIG. 7 is a block diagram illustrating an internal configuration example of a reception device 2A as a second embodiment.

Note that, in the second embodiment, the configuration of the tactile presentation system 100 is similar to that in the first embodiment except that the reception device 2A is provided instead of the reception device 2, and description thereof is omitted.

Furthermore, in the following description, portions similar to those already described are given the same reference numerals and the same step numbers, and description thereof is omitted.

In FIG. 7, the reception device 2A is different from the reception device 2 according to the first embodiment in that a control unit 25A is provided instead of the control unit 25.

The control unit 25A is different from the control unit 25 in that the control unit 25A includes an interpolation signal generation unit F1A instead of the interpolation signal generation unit F1.

The interpolation signal generation unit F1A generates an interpolation signal in a loss section on the basis of a human perception model related to tactile sensation rather than a physical model related to tactile sensation.

More specifically, as the generation of an interpolation signal based on such a perception model, the interpolation signal generation unit F1A in the present example generates an interpolation signal based on subjective tactile intensity and an envelope shape of a tactile signal in an adjacent section.

Here, it is said that human tactile sensation is mainly caused by subjective tactile intensity determined from amplitude and frequency and an envelope shape of a vibration waveform for a vibration at a frequency of 200 Hz or more with respect to discriminating ability to distinguish a difference between two vibration stimuli. That is, by making the subject tactile intensity and the envelope shape the same, it is possible to generate two signals that are difficult for the human tactile sensation to distinguish.

The second embodiment proposes a method for generating an interpolation signal using such a human perception mechanism.

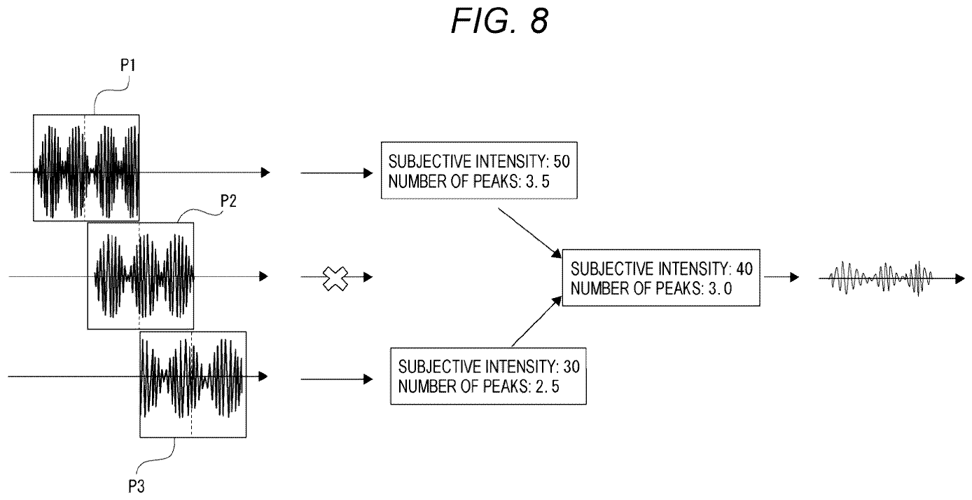

The interpolation signal generation method as the second embodiment will be described with reference to FIG. 8.

First, as a premise, in the second embodiment, an example in which a half-overlap method is employed as a method for encoding a tactile signal will be described. In the half-overlap method, the transmission device 1 cuts out frames Fr while overlapping signals by half, and performs encoding for each frame Fr (see a left side of the drawing). In this case, too, packetization is performed in units of frames Fr. Here, too, three consecutive packets in time series are indicated as packets P1, P2, and P3.

In this case, the reception device 2A outputs tactile signals decoded in units of packets while overlapping the tactile signals by half.

Here, it is assumed that a central packet (P2) among the three consecutive packets (P1 to P3) has been lost. Note that, as described for confirmation, in the half-overlap method, it is assumed that signals are synthesized half by half with adjacent packets, and in a case where one packet is lost, a signal to be synthesized with signals of packets before and after the packet becomes unknown, so that appropriate tactile presentation cannot be performed.

In a case where a packet loss is detected, the interpolation signal generation unit F1A obtains subjective tactile intensity and an envelope shape for each of tactile signals of adjacent packets before and after the lost packet.

With respect to the subjective tactile intensity, a sensory gain indicating how many times amplitude D of a certain vibration is a minimum detection threshold T at a frequency of the vibration is obtained, the sensory gain being expressed as follows.

$$\begin{matrix}[ Math . 2 ] & \\ SL = 20 {log}_{10} \frac{D}{T} & [ Expression 2 ]\end{matrix}$$

Note that the minimum detection threshold I refers to a threshold as to whether or not a human feels the vibration as a tactile sensation (a threshold with respect to the amplitude D).

Alternatively, as the subjective tactile intensity, tactile intensity, which is obtained by giving the sensory gain a correction coefficient b of sensitivity for each frequency, can also be obtained, the tactile intensity being expressed as follows.

$$\begin{matrix}[ Math . 3 ] & \\ Intensity = {( \frac{D}{T} )}^{b} & [ Expression 3 ]\end{matrix}$$

Note that, as for the subjective tactile intensity, one of other known indices can be used, instead, as long as the index represents subjective human stimulation intensity in tactile sensation.

Furthermore, the envelope shape can be obtained as follows. That is, the envelope shape can be obtained by a known method such as applying a low-pass filter to a square value of a signal, calculating an analysis signal through the Hilbert transform and obtaining an absolute value of the analysis signal, or obtaining an average amplitude of a signal at regular intervals.

After obtaining the subjective tactile intensity and the envelope shape for each of tactile signals of adjacent packets before and after a lost packet, a subjective tactile intensity and an envelope shape of an interpolation signal are determined on the basis of the subjective tactile intensities and the envelope shapes. For example, values of the subjective tactile intensities are used as they are, and values of the number of peaks are used as the envelope shapes. In this case, the subjective tactile intensity and the envelope shape of the interpolation signal are obtained by linearly interpolating the values of the subjective tactile intensities and the values of the number of peaks of the envelopes of the adjacent packets before and after the interpolation signal. The illustrated example illustrates a case where the tactile subjective intensity and the number of peaks of the adjacent packet before the lost packet are 50 and 3.5, respectively, the tactile subjective intensity and the number of peaks of the adjacent packet after the lost packet are 30 and 2.5, respectively, and these are linearly interpolated to determine that the subjective tactile intensity and the number of peaks of the interpolation signal are 40 and 3.0, respectively.

The interpolation signal generation unit F1A generates, as the interpolation signal for the lost packet, a signal having the subjective tactile intensity and the number of peaks of the envelope obtained through such linear interpolation.

In this case, it is sufficient that the frequency of the interpolation signal is 200 Hz or more, and the frequency may be determined in accordance with a value easily perceived by a human, a resonance characteristic of a tactile presentation device, or the like. For example, an amplitude-modulated wave having a certain frequency of 200 Hz or more, a subjective intensity of 40, and the number of peaks of an envelope of 3 is generated. This interpolation signal need not have the same frequency as a lost original waveform, according to the human perception mechanism. Other signal components such as noise may be added to the interpolation signal in addition to the amplitude-modulated wave.

By employing the interpolation signal generation method described above, it is possible to interpolate a tactile signal in a loss section on the basis of subjective tactile intensity and an envelope shape, which are main factors in a case where a person discriminates between different tactile stimuli.

It is therefore possible to make it difficult for the user to notice a loss of a tactile signal, and it is possible to improve the user's sense of immersion in tactile content.

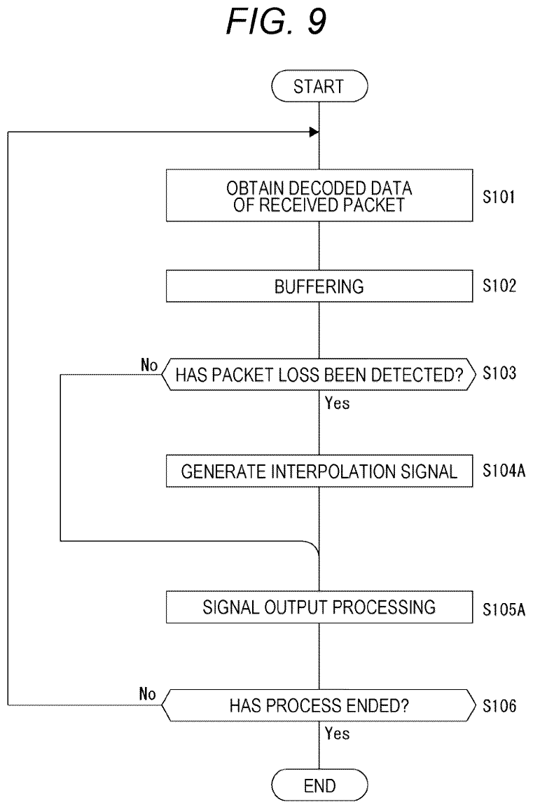

FIG. 9 is a flowchart illustrating an example of a processing procedure for achieving the interpolation signal generation method as the second embodiment described above.

Note that, in the present example, the control unit 25A illustrated in FIG. 7 performs a process illustrated in FIG. 9, or more specifically, the CPU of the control unit 25A performs the process on the basis of a program stored in a predetermined storage device, such as a ROM, of the control unit 25A.

This case is similar to the case of FIG. 6 in that the processing in steps S101 to S103 is performed.

If determining in step S103 that a packet loss has been detected, the control unit 25A proceeds to step S104A and performs interpolation signal generation processing. More specifically, as the interpolation signal generation processing in step S104A, interpolation signal generation processing based on subjective tactile intensities and envelope shapes in adjacent packets before and after a lost packet described above is performed.

Next, in step S105A subsequent to step S104A, the control unit 25A performs signal output processing. As the signal output processing in step S105A in this example, signal output processing based on the half-overlap method is performed. More specifically, if it is determined in step S103 that a packet loss has been detected, processing is performed to sequentially output, to the tactile presentation device 4, a combined signal of a tactile signal in a second half section of the packet P1 and a signal in a first half section of the interpolation signal and a combined signal of a signal in a second half section of the interpolation signal and a tactile signal in a first half section of the packet P3 for tactile signals of the most recently received packet (referred to as packet P3) and the packet (referred to as packet P1) two packets before the foregoing packet, and the interpolation signal generated in step S104A.

If it is determined in step S103 that a packet loss has not been detected, on the other hand, processing is performed to sequentially output, to the tactile presentation device 4, a combined signal of the tactile signal in the second half section of the packet P1 and a tactile signal in a first half section of the packet P2 (a packet received immediately before the packet P3) and a combined signal of a tactile signal in a second half section of the packet P2 and the tactile signal in the first half section of the packet P3.

The control unit 25A advances the process to step S108 in response to the execution of the signal output processing in step S105A, but processing in step S108 and subsequent steps is similar to that in the case of FIG. 6, and redundant description thereof is avoided.

### 3. Third Embodiment

In a third embodiment, as another example in which an interpolation signal is generated on the basis of a physical model related to tactile sensation, an interpolation signal based on an interlocking characteristic between motion and vibration is generated.

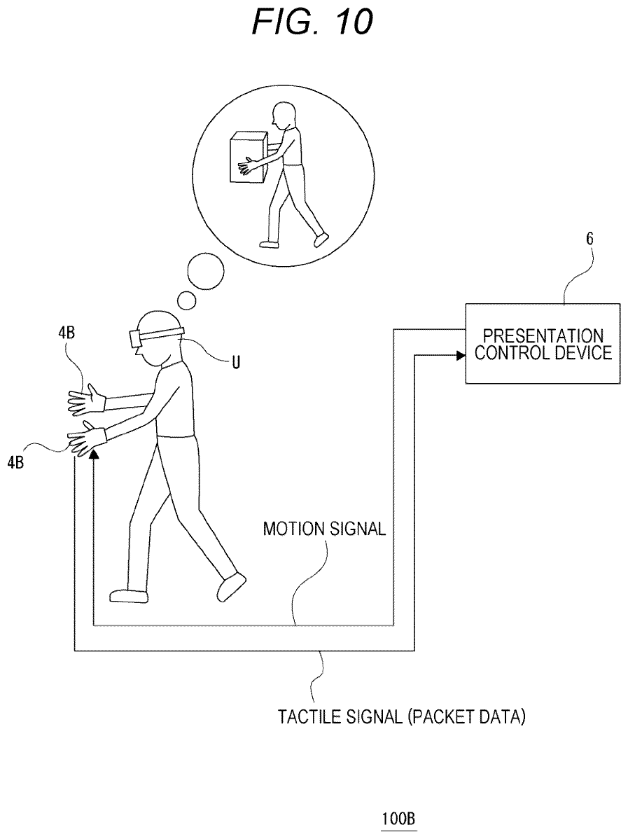

FIG. 10 is a block diagram illustrating a configuration example of a tactile presentation system 100B as the third embodiment.

As illustrated, the tactile presentation system 100B includes a tactile presentation device 4B worn by a user U as a recipient, and a presentation control device 6. Although a mode in which each of hands of the user U holds the tactile presentation device 4B is described, only processing for one of the tactile presentation devices 4B will be representatively described hereinafter since the presentation control device 6 performs similar processing on each tactile presentation device 4B.

The tactile presentation system 100B is configured as a system that performs tactile presentation in a virtual reality (VR) game. The user U as a player of a game holds a tactile presentation device 4B of a controller type including a motion sensor (a motion sensor 43 described later) and a tactile presentation unit 5. A motion signal obtained by the motion sensor is input from the tactile presentation device 4B to the presentation control device 6. The presentation control device 6 is configured as a computer device such as a personal computer, for example, generates a tactile signal linked to the input motion signal, packetizes the tactile signal, and outputs the packetized tactile signal to the tactile presentation device 4B.

Here, the presentation control device 6 identifies a contact mode of a virtual object with which a virtual hand of the user U in a VR space is in contact from the input motion signal, generates an appropriate tactile signal according to the identified contact mode, and outputs the tactile signal to the tactile presentation device 4B.

As a result, the user U can experience as if he/she were touching the virtual object in the VR space.

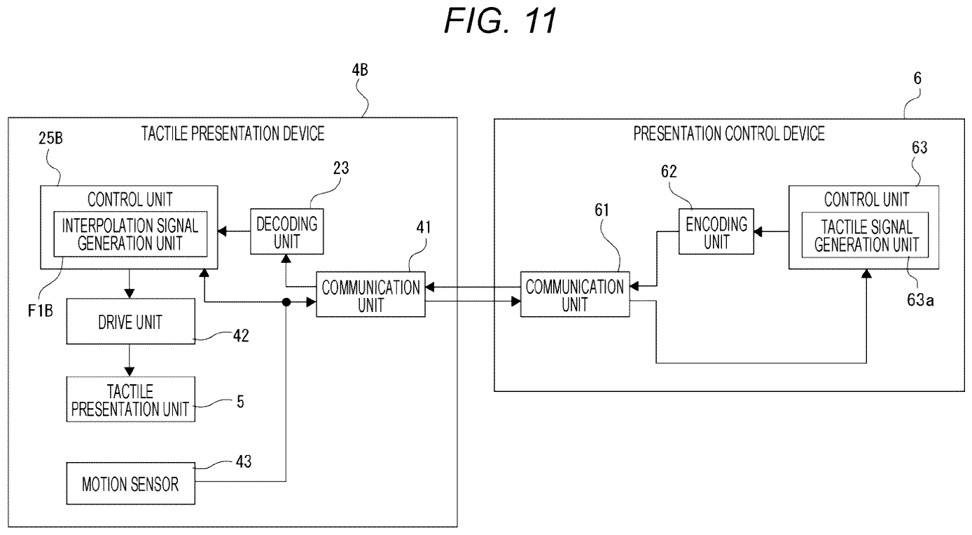

FIG. 11 is a block diagram illustrating an internal configuration example of the tactile presentation device 4B and the presentation control device 6.

As illustrated, the tactile presentation device 4B includes a communication unit 41, a drive unit 42, and a tactile presentation unit 5, and also includes the motion sensor 43, a decoding unit 23, and a control unit 25B.

The motion sensor 43 is a sensor that detects a motion signal indicating motion of the user U, and includes, for example, an acceleration sensor, an angular velocity sensor, or the like. A motion signal detected by the motion sensor 43 is output to the presentation control device 6 via the communication unit 41.

As described above, the decoding unit 23 decodes coded data of a tactile signal to obtain a tactile signal.

The control unit 25B includes, for example, a microcomputer including a CPU, a ROM, a RAM, and the like, and the CPU performs processing according to a program stored in the ROM to control the entirety of the tactile presentation device 4B.

For example, the control unit 25B outputs a tactile signal decoded by the decoding unit 23 to the drive unit 42 to cause the tactile presentation unit 5 to perform a tactile presentation operation based on the tactile signal.

Furthermore, in particular, the control unit 25B has a function as an interpolation signal generation unit F1B, but the interpolation signal generation unit F1B will be described later.

The presentation control device 6 includes a communication unit 61, an encoding unit 62, and a control unit 63.

The communication unit 61 performs data communication with the communication unit 41 of the tactile presentation device 4B. Note that a connection between the tactile presentation device 4B and the presentation control device 6 for the data communication may be a wired connection or a wireless connection.

The control unit 63 includes, for example, a microcomputer including a CPU, a ROM, a RAM, and the like, and the CPU performs processing according to a program stored in the ROM to control the entirety of the presentation control device 6.

The control unit 63 has a function as a tactile signal generation unit 63a. The tactile signal generation unit 63a generates a tactile signal interlocked with a motion signal input from the tactile presentation device 4B via the communication unit 61 on the basis of the motion signal. More specifically, object information (at least information indicating a type of object) regarding a virtual object with which the virtual hand of the user U has come in contact in the VR space and information regarding a way of contact (stroke or grasp, and speed thereof) are analyzed and obtained from the input motion signal, and an appropriate tactile signal corresponding to the object information and the way of contact is generated.

Furthermore, the control unit 63 performs processing for causing the encoding unit 62 to encode the tactile signal generated in this manner, packetizing coded data, and outputting the packetized data to the tactile presentation device 4B via the communication unit 61.

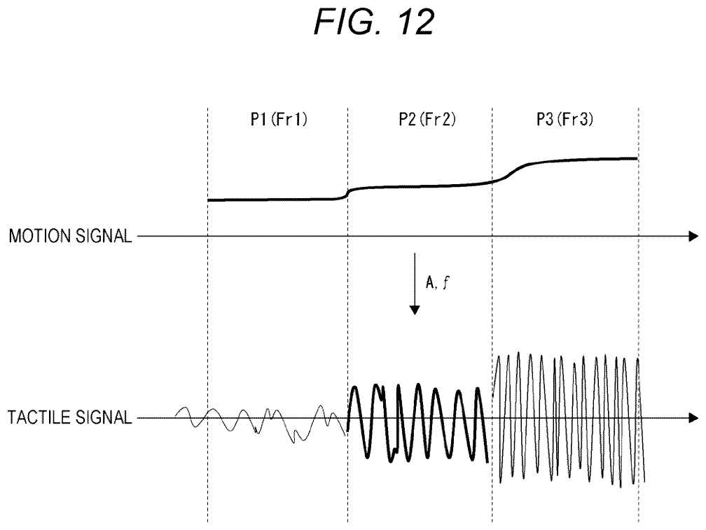

An interpolation signal generating method (an interpolation signal generation method as the third embodiment) by the interpolation signal generation unit F1B will be described with reference to FIG. 12.

First, as a premise, it is assumed in this case that a motion signal from the motion sensor 43 is also divided by frames Fr similar to those for a tactile signal. Moreover, in the tactile presentation device 4B, it is assumed that the control unit 25B can identify frames Fr of a tactile signal synchronized with the frames Fr of the motion signal. For example, the control unit 63 of the presentation control device 6 assigns, as packet IDs of packet data of the tactile signal, packet IDs with the same numbers as frame numbers of the frames Fr of the motion signal in synchronization with the tactile signal so that the control unit 25B can identify the frames Fr of the tactile signal synchronized with the frames Fr of the motion signal.

In a case where the control unit 25B (interpolation signal generation unit F1B) has detected a packet loss of the tactile signal, the control unit 25B generates an interpolation signal based on the interlocking characteristic between motion and vibration.

More specifically, in the generation of an interpolation signal in this case, a physical model is used in which amplitude and frequency of vibration caused by contact with an object increase as speed of the contact increases. This physical model can be rephrased as a model of “in a case where an object is touched quickly, stronger and finer vibration is transmitted to the hand”. In the present example, this physical model applies because motion speed (motion speed of the hand of the user U) of the tactile presentation device 4B obtained by the motion sensor 43 represents speed of contact with a virtual object and the vibration to be presented is a vibration caused by the contact with the virtual object.

A specific interpolation signal generation method will be described hereinafter.

Here, for the sake of explanation, the numbers of the frames Fr of the motion signal and the numbers of the frames Fr of the tactile signal synchronized with the frames Fr of the motion signal are treated as the same numbers. Furthermore, here, it is assumed that a tactile signal of the frame Fr2 has been lost among tactile signals in the consecutive sections from the frame Fr1 to the frame Fr3.

First, for the frame Fr1 as a previous frame of the lost frame Fr, velocity of motion identified from the motion signal and amplitude (vibration amplitude) and frequency of the tactile signal are obtained. Furthermore, for the frame Fr3 as a frame after the lost frame Fr, velocity of motion identified from the motion signal and amplitude and frequency of the tactile signal are similarly obtained. A relationship between the velocity of the motion and the amplitude and frequency of the vibration is then identified on the basis of the obtained information. Velocity of motion in the frame Fr2, in which the tactile signal has been lost, is then applied to the identified relationship to generate an interpolation signal for the frame Fr2.

More specifically, it is assumed that a physical model in which velocity and vibration amplitude/frequency have a proportional relationship has been obtained from the velocity of the motion and the amplitude and frequency of the vibration of the frame Fr1 and the velocity of the motion and the amplitude and frequency of the vibration of the frame Fr3, the physical model being expressed as follows:

$$\begin{matrix}[ Math . 4 ] & \\ A = {μ}_{A} v & [ Expression 4 ]\end{matrix}$$

$$f = {μ}_{f} v$$

This can be derived, for example, by applying a relationship between velocity and amplitude to a linear function from a velocity v₍ₙ₋₁₎ and an amplitude A₍ₙ₋₁₎ Of the frame Fr1 as the previous frame of the lost frame Fr2 and a velocity v₍ₙ₊₁₎ and an amplitude A₍ₙ₊₁₎ of the frame Fr3 as the subsequent frame, and μ_{A} and μ_{f} in the above [Expression 4] correspond to inclinations thereof. Here, in a case where a lost vibration signal (tactile signal) dₙ is interpolated from the velocity v₍ₙ₋₁₎ and the vibration signal d₍ₙ₋₁₎ of the frame Fr1 as the previous frame, the vibration amplitude Aₙ and the frequency fₙ of the interpolation signal are expressed as follows:

$$\begin{matrix}[ Math . 5 ] & \\ {A}_{n} = {μ}_{A} {v}_{n} & [ Expression 5 ]\end{matrix}$$

$${f}_{n} = {μ}_{f} {v}_{n}$$

An interpolation signal satisfying this condition, therefore, may be generated. As a result, it is possible to present a vibration in which amplitude and frequency increase with respect to a way of contact as in the example of FIG. 12 in which speed of motion increases.

Note that, in order to increase accuracy of deriving the relationship between speed of motion and vibration amplitude/frequency, it is desirable to use not only one frame immediately before a loss but a plurality of frames as in the present example. In this case, if only information regarding a plurality of frames before the lost frame is used, it is not necessary to wait for reception and decoding of several packets after the lost packet for the derivation of a relationship, and it is possible to reduce a delay until an interpolation signal is generated. Perception of a surface shape and texture of an object as presented in the present example is considered to be processed while strongly linking, in the human brain, a vibration perceived by the skin and the human's own motion, and a delay of only the vibration applied to the hand might greatly affect the perception. It is therefore important to reduce the delay.

By preparing the physical model as described above in accordance with various ways of contact and physical properties of virtual objects, the physical model can be applied to contact with objects in general.

As a result, it is possible to perform packet loss concealment using an interpolation signal interlocked on the basis of motion information and a physical model, and it is possible to present an interpolation signal without discomfort to the user as feedback of his/her motion.

Note that it is assumed in the present method that a way of contact of a person with an object does not abruptly change between before and after a frame Fr that has been lost, that is, the person does not suddenly touch an object different from that one frame before or does not grasp an object that the person was stroking one frame before. A fact that information of a signal of a lost packet can be estimated from information of preceding and following packets is based on this assumption. It is expected in practice that the way of contact might suddenly change in one frame, but it is important to eliminate unnaturalness to conceal a packet loss and to achieve sufficient packet loss concealment.

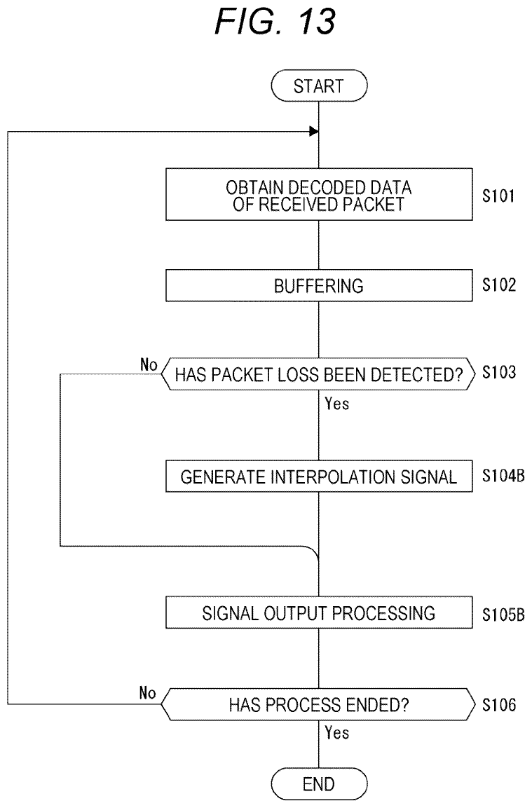

FIG. 13 is a flowchart illustrating an example of a processing procedure for achieving the interpolation signal generation method as the third embodiment described above.

Note that, in the present example, the control unit 25B illustrated in FIG. 11 performs a process illustrated in FIG. 13, or more specifically, the CPU of the control unit 25B performs the process on the basis of a program stored in a predetermined storage device, such as a ROM, of the control unit 25B.

This case is similar to the case of FIG. 6 in that the processing in steps S101 to S103 is performed.

If determining in step S103 that a packet loss has been detected, the control unit 25B proceeds to step S104B and performs interpolation signal generation processing. More specifically, as the interpolation signal generation processing in step S104B, the interpolation signal generation processing based on the interlocking characteristic of motion and vibration using a motion signal detected by the motion sensor 43 is performed as described above. More specifically, for example, the interpolation signal generation processing based on [Expression 5] described above is performed, but since details have already been described, redundant description thereof is avoided.

In step S105B subsequent to step S104B, the control unit 25B performs signal output processing. As the signal output processing in step S105B, processing for outputting the interpolation signal generated in step S104B or the tactile signal of the frame Fr to be output (if a packet loss has not been detected in step S103) to the drive unit 42 is performed.

The control unit 25B advances the process to step S108 in response to the execution of the signal output processing in step S105B, but processing in step S108 and subsequent steps is similar to that in the case of FIG. 6, and redundant description thereof is avoided.

Note that although a case where the tactile presentation device 4B generates an interpolation signal using a motion signal detected by the motion sensor 43 thereof has been described above as an example of generation of an interpolation signal based on a motion signal, the interpolation signal generation method as the third embodiment can also be applied to a case where content in which a motion signal and a tactile signal are recorded is read from a stored medium and transmitted to the tactile presentation device 4B. Note that, in this case, it is assumed that the tactile presentation device 4B also reproduces a motion corresponding to the motion signal.

In this case, if only the motion signal can be received in a frame Fr in which the tactile signal has been lost, an interpolation signal can be generated. Since motion information can be generally transmitted with a smaller amount of information than vibration information, it is conceivable that only the motion information can be communicated even if communication of the vibration information fails. It is therefore preferable to generate an interpolation signal based on a motion signal as in the third embodiment.

### 4. Fourth Embodiment

Next, a fourth embodiment will be described. The fourth embodiment relates to selection and setting of an interpolation method.

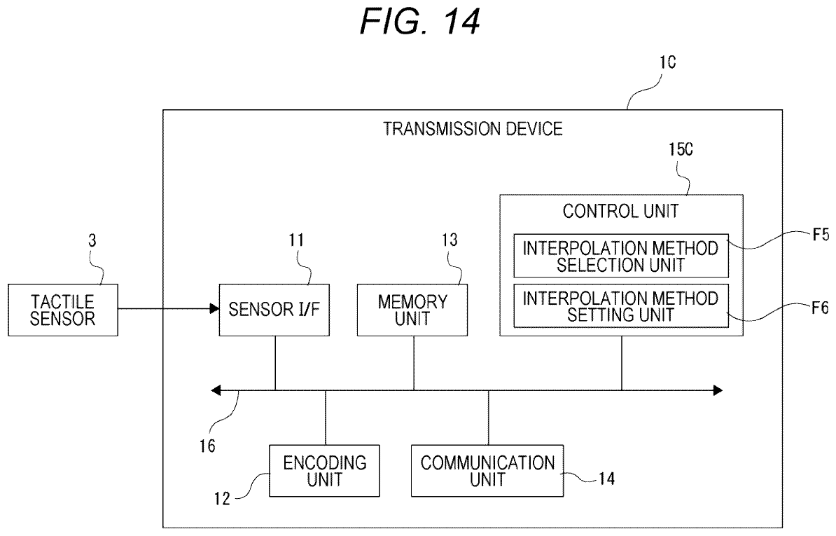

FIG. 14 is a block diagram for describing an internal configuration example of a transmission device 1C as a fourth embodiment, and illustrates the tactile sensor 3 together with the internal configuration example of the transmission device 1C.

The transmission device 1C is different from the transmission device 1 illustrated in FIG. 2 in that a control unit 15C is provided instead of the control unit 15. The control unit 15C is different from the control unit 15 in that the control unit 15C has functions as an interpolation method selection unit F5 and an interpolation method setting unit F6.

The interpolation method selection unit F5 selects an interpolation method for interpolating a tactile signal that has been lost at a time of transmission on the basis of a result of performing a signal analysis based on a physical model or a human perception model related to tactile sensation as a signal analysis of the tactile signal.

The interpolation method setting unit F6 performs processing in such a way as to generate, as transmission data of the tactile signal, transmission data in which additional information indicating the interpolation method selected by the interpolation method selection unit F5 is added to the tactile signal.

In the present embodiment, an interpolation method ID is added as the additional information indicating the interpolation method.

Here, in the present example, a case will be described where interpolation methods as selection candidates are the interpolation method based on the damped sine wave model described in the first embodiment and the interpolation method based on the human perception model described in the second embodiment.

In the present example, therefore, the interpolation method selection unit F5 performs a signal analysis based on the damped sine wave model and the human perception model as the signal analysis for selecting the interpolation method.

In this case, the interpolation method is selected and set in units of frames Fr of the tactile signal.

Here, as understood from the above description of the second embodiment, the interpolation method based on the human perception model can be suitably applied under a condition that the frequency of the tactile signal is 200 Hz or more.

As the selection of the interpolation method based on a result of the signal analysis based on the human perception model, therefore, the interpolation method selection unit F5 selects an interpolation method based on a result of a determination whether or not energy in a band of a predetermined frequency or more, or more specifically, a band of 200 Hz or more, of the tactile signal is greater than or equal to a predetermined threshold.

More specifically, at least if the energy in the band of 200 Hz or more is greater than or equal to the predetermined threshold for the tactile signal of the frame Fr as the target of the selection and setting of the interpolation method, the interpolation method based on the human perception model is selected as the interpolation method for the target frame Fr.

Furthermore, if the energy in the band of 200 Hz or more in the tactile signal of the target frame Fr is not greater than or equal to the predetermined threshold, the interpolation method selection unit F5 in the present example performs processing for determining whether or not the interpolation method based on the damped limited wave model should be selected.

The determination is made on the basis of an evaluation value obtained by calculating a fitting evaluation value for a damped sine wave (Ae^{-λt} sin (2 πft)) using the following [Expression 6] for a tactile signal for three consecutive frames (hereinafter referred to as a “signal y[t]”) including the tactile signal of the target frame Fr and tactile signals of preceding and following frames Fr.

$$\begin{matrix}[ Math . 6 ] & \\ - {min}_{A , λ , f} {\sum }_{t} {( y [ t ] - {Ae}^{- λ t} sin ( 2 π ft ) )}^{2} & [ Expression 6 ]\end{matrix}$$

Here, the fitting evaluation value represented by [Expression 6] means a polarity inversion value of a value calculated using Σ in a case where a combination of A, λ, and f with which the value calculated using Σ (a square error between the signal y[t] and the damped sine wave) becomes minimum is used.

If the fitting evaluation value is larger than or equal to a threshold, the interpolation method selection unit F5 selects the interpolation method based on the damped sine wave model as the interpolation method for the target frame Fr.

Note that, in the present example, if the fitting evaluation value is smaller than the threshold, the interpolation method selection unit F5 obtains a selection result indicating that there is no interpolation method. In this case, ID information indicating that there is no interpolation method is generated as the interpolation method ID.

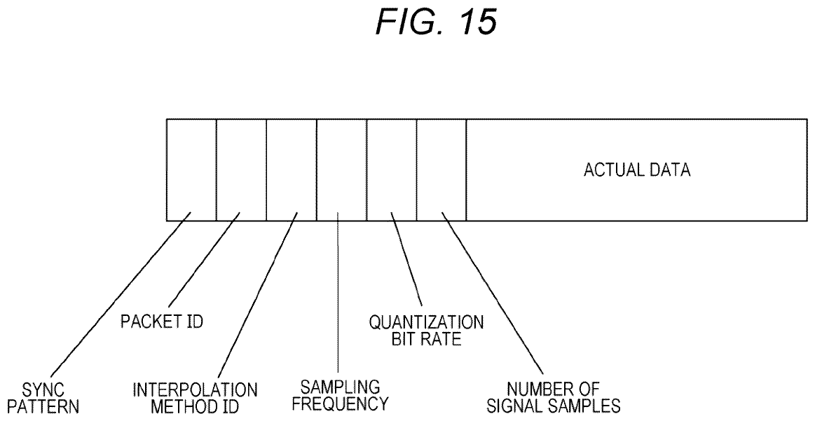

FIG. 15 is a diagram illustrating an example of data structure of packet data according to the fourth embodiment.

As illustrated, the selected interpolation method ID can be stored as one piece of additional information for actual data of the tactile signal in the packet data.

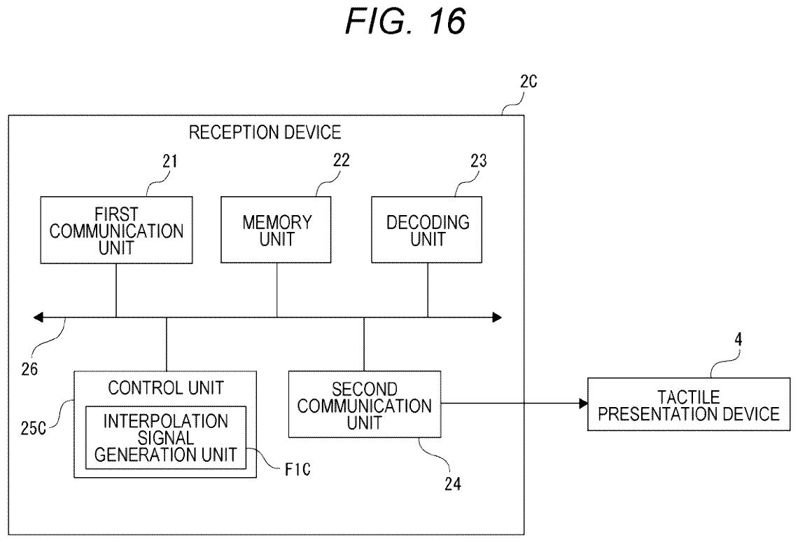

FIG. 16 is a block diagram for describing an internal configuration example of a reception device 2C as the fourth embodiment, and illustrates the tactile presentation device 4 together with the internal configuration example of the reception device 2C.

The reception device 2C is different from the reception device 2 illustrated in FIG. 4 in that a control unit 25C is provided instead of the control unit 25. The control unit 25C is different from the control unit 25 in that the control unit 25C includes an interpolation signal generation unit F1C instead of the interpolation signal generation unit F1.

The interpolation signal generation unit F1C selects an interpolation method for a tactile signal on the basis of additional information added to the tactile signal, or more specifically, the information regarding the interpolation method ID added to the tactile signal in the present example.

As can be seen with reference to FIG. 15, in the present example, the interpolation method ID as the additional information indicating the interpolation method is added for each frame Fr (for each of unit sections) of the tactile signal, and therefore the interpolation signal generation unit F1C selects the interpolation method for each frame Fr on the basis of the interpolation method ID added for each frame Fr.

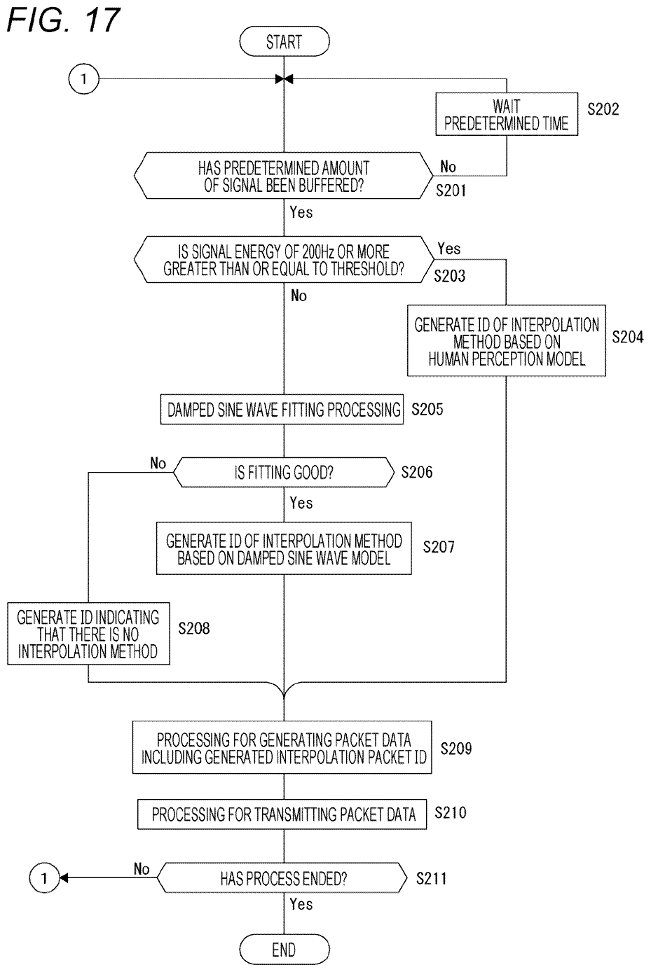

FIG. 17 is a flowchart illustrating an example of a processing procedure for achieving functions of the transmission device 1C as the fourth embodiment described above.

Note that, in the present example, the control unit 15C illustrated in FIG. 14 performs a process illustrated in FIG. 17, or more specifically, the CPU of the control unit 15C performs the process on the basis of a program stored in a predetermined storage device, such as a ROM, of the control unit 15C.

First, in step S201, the control unit 15C determines whether or not a predetermined amount of signal (tactile signal) has been buffered, and if determining that the predetermined amount of signal has not been buffered, waits a predetermined time in step S202, and performs the processing in step S201 again.

Since there is a case where a tactile signal (signal y[t]) for three consecutive frames including a target frame Fr and preceding and following frames thereof is required for the signal analysis processing for selecting the interpolation method for the target frame Fr in the present embodiment, the control unit 15C waits until the tactile signal for the three frames has been buffered as a result of the processing in steps S201 and S202 described above.

If determining in step S201 that the predetermined amount of signal has been buffered, the control unit 15C proceeds to step S203 and determines whether or not signal energy of 200 Hz or more is greater than or equal to a threshold. In the present example, the determination is performed as processing for determining whether or not the signal energy of 200 Hz or more is larger than or equal to the threshold for the signal y[t] described above, that is, the tactile signal for the three consecutive frames including the target frame Fr and the preceding and following frames thereof. Here, the signal energy is obtained as, for example, average amplitude or the like.

If determining in step S203 that the signal energy of 200 Hz or more is greater than or equal to the threshold, the control unit 15C proceeds to step S204, generates an ID of the interpolation method (interpolation method ID) based on the human perception model, and advances the process to step S209.

If determining in step S203 that the signal energy of 200 Hz or more is not greater than or equal to the threshold, the control unit 15C proceeds to step S205 and performs processing for calculating an evaluation value based on [Expression 6] using the above-described signal y[t] as damped sine wave fitting processing.

Next, in subsequent step S206, the control unit 15C determines whether or not the fitting is good, or more specifically, whether or not the evaluation value calculated in step S205 is larger than or equal to a threshold. If determining that the evaluation value is larger than or equal to the threshold and the fitting is good, the control unit 15C proceeds to step S207, generates an ID of the interpolation method (interpolation method ID) based on the damped sine wave model, and advances the process to step S209.

If determining in step S206 that the fitting is not good, on the other hand, the control unit 15C proceeds to step S208, generates an ID (interpolation method ID) indicating that there is no interpolation method, and advances the process to step S209.

In step S209, the control unit 15C performs processing for generating packet data including the generated interpolation method ID.

Here, as described in the first and second embodiments, the generation of an interpolation signal based on the damped sine wave model and the generation of an interpolation signal based on the human perception model are performed using tactile signals of preceding and following frames of a lost frame Fr. In view of this point, in the present example, an interpolation method ID is given to a frame Fr immediately after a target frame Fr. That is, in the processing in step S209, processing for generating packet data to which the generated interpolation method ID is added as packet data including the tactile signal of the frame Fr immediately after the target frame Fr is performed. As a result, in a case where a packet is lost on the reception device 2C side, an interpolation signal for the lost packet can be generated using an appropriate interpolation method with reference to an interpolation method ID added to a packet immediately after the packet.

In step S210 subsequent to step S209, the control unit 15C performs processing for transmitting, to the reception device 2C, the packet data generated in step S209 via the communication unit 14 as packet data transmission processing.

In step S211 subsequent to step S210, the control unit 15C determines whether or not the processing has ended, that is, whether or not a predetermined processing end condition has been satisfied, and if determining that the processing has not ended, the process returns to step S201. As a result, the processing for selecting an interpolation method and the processing for setting the selected interpolation method are performed for a next target frame.

The control unit 15C ends the process illustrated in FIG. 17 in response to the determination in step S211 that the process has ended.

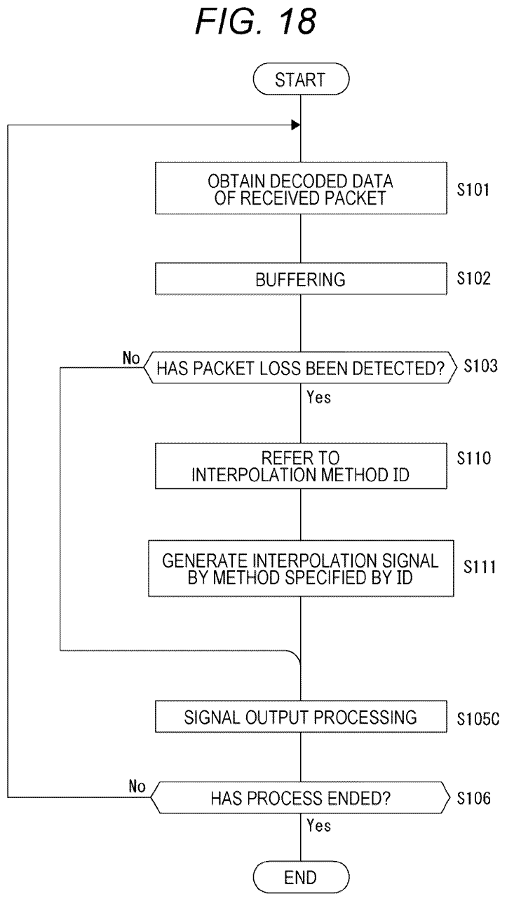

FIG. 18 is a flowchart illustrating an example of a processing procedure for achieving functions of the reception device 2C as the fourth embodiment.

In the present example, the control unit 25C illustrated in FIG. 16 performs a process illustrated in FIG. 18, or more specifically, the CPU of the control unit 25C performs the process on the basis of a program stored in a predetermined storage device, such as a ROM, of the control unit 25C.

This case is similar to the case of FIG. 6 in that the processing in steps S101 to S103 is performed.

If determining that a packet loss has been detected in step S103, the control unit 25C proceeds to step S110 and refers to the interpolation method ID. As described above, in the present example, an interpolation method ID indicating an interpolation method for a lost packet is added to a packet immediately after the lost packet. In step S110, therefore, the interpolation method ID added to the packet immediately after the lost packet is referred to.

In step S111 subsequent to step S110, the control unit 15C performs processing for generating an interpolation signal by the method specified by the ID. That is, if the interpolation method ID referred to in step S110 indicates the interpolation method based on the damped sine wave model, an interpolation signal is generated using the interpolation method based on the damped sine wave model as described in the first embodiment, and if the interpolation method ID referred to indicates the interpolation method based on the human perception model, an interpolation signal is generated using the interpolation method based on the human perception model as described in the second embodiment. Note that, in a case where the interpolation method ID referred to indicates that there is no interpolation method, the control unit 15C does not generate an interpolation signal. That is, in this case, signal interpolation in the loss section is not performed.

In response to the execution of the processing in step S111, the control unit 15C advances the process to step S105C and performs signal output processing. As the signal output processing in step S105C, processing for outputting the interpolation signal generated in step S111 or the tactile signal of the frame Fr to be output (if a packet loss has not been detected in step S103) to the tactile presentation device 4 via the second communication unit 24 is performed. Note that, in a case where the half-overlap method is employed as described in the second embodiment, signal output processing corresponding to the half-overlap method is performed.

The control unit 25C advances the process to step S108 in response to the execution of the signal output processing in step S105C, but processing in step S108 and subsequent steps is similar to that in the case of FIG. 6, and redundant description thereof is avoided.

Here, although a case where the selection candidates of the interpolation method are the interpolation method based on the damped sine wave model and the interpolation method based on the human perception model has been described above, the interpolation method can be selected on the basis of information regarding an application for which a tactile signal is used in a case where these two interpolation methods and the interpolation method based on the interlocking characteristic of motion and vibration are candidates, as in the case of application to a VR system according to the third embodiment. More specifically, in this case, the interpolation method selection unit F5 determines whether or not the application for which the tactile signal is used is an application of VR as illustrated in FIG. 10, and if an affirmative result is obtained, selects the interpolation method based on the interlocking characteristic of motion and vibration as the interpolation method. If a negative result is obtained, for example, the interpolation method based on the damped sine wave model or the interpolation method based on the human perception model may be selected by performing the same processing as in FIG. 17.

Furthermore, the interpolation method can also be selected on the basis of information regarding the amount of delay or the amount of operation in a case where the method is employed.

In a case where both the selection condition (S203) of the interpolation method based on the human perception model and the selection condition (S205 and S206) of the interpolation method based on the damped sine wave model illustrated in FIG. 17 are satisfied, for example, it is conceivable to select one of the interpolation methods on the basis of information regarding the amount of delay or the amount of operation in each of cases where these interpolation methods are employed.

More specifically, since the amount of operation is larger in a case where the interpolation method based on the damped sine wave model is employed, the interpolation method based on the human perception model is selected in a case where the interpolation method is selected on the basis of the amount of operation. Furthermore, since the amount of delay is also larger in a case where the interpolation method based on the damped sine wave model is employed, the interpolation method based on the human perception model is selected even in a case where the interpolation method is selected on the basis of the amount of delay.

Furthermore, it is also conceivable to add an interpolation method ID for each frequency band of a tactile signal. In this case, the generation of an interpolation signal can be performed on a reception side by different interpolation methods for different frequency bands.

For example, in the selection of an interpolation method, a target tactile signal is divided into a low-frequency component of less than 200 Hz and a high-frequency component of 200 Hz or more. For the high-frequency component of 200 Hz or more, it is determined whether the high-frequency component has energy greater than or equal to a certain level, and if a positive result is obtained, an interpolation method ID indicating the interpolation method based on the perception model is generated as an interpolation method ID for the high-frequency component, and is added as the interpolation method ID for the high-frequency component. If a negative result is obtained in the above determination, on the other hand, it is assumed that the signal does not greatly affect perception in the first place, and an interpolation method ID indicating that interpolation is not performed is added as the interpolation method ID for the high-frequency component in this case.

Furthermore, for the low-frequency component of less than 200 Hz, it is determined whether or not the interpolation method based on the damped sine wave model is applicable, and if the interpolation method based on the damped sine wave model is applicable, an ID indicating the interpolation method based on the damped sine wave model is generated as interpolation method ID for the low-frequency component, and the ID is added as the interpolation method ID for the low-frequency component.

As a result, it is possible to set an appropriate interpolation method according to properties of a waveform for each frequency band of a tactile signal.

Note that, in a case where an interpolation method is determined from information regarding an application or a system, such as a case where it has already been determined to handle vibration of 200 Hz or more due to characteristics of an actuator used as the tactile presentation unit 5, a case where it has already been determined that the actuator is used in a VR game involving motion information, or a case where it has already been determined to handle collision vibration that can be accurately expressed by a damped vibration wave as content, the signal analysis may be omitted, and an interpolation method ID corresponding to all sections (all bands) may be added. In a case where calculation resources available for the interpolation processing in the reception device are limited, too, the signal analysis may be omitted, and an interpolation method ID available in the resources may be added to all sections (all bands). For example, since the amount of processing of the interpolation method based on the perception model is relatively small among the methods described in the embodiments so far, this interpolation method may be selected depending on calculation resources.

Furthermore, an interpolation method ID is not limited to being added to a packet immediately after a lost packet as described above. For example, it is also conceivable to add an interpolation method ID to a packet immediately before a lost packet. An interpolation method ID added to a packet immediately after a lost packet will be referred to as a “forward packet interpolation method ID”, and an interpolation method ID added to a packet immediately before a lost packet will be referred to as a “backward packet interpolation method ID” hereinafter.

The backward packet interpolation method ID is based on a premise that interpolation is performed on the basis of a tactile signal of a packet received before a lost packet in a case of a packet loss. For example, as in the method described in the third embodiment, the backward packet interpolation method ID can be added in a case where an interpolation signal of a lost packet can be generated only from a tactile signal of a packet immediately before the lost packet.

It is also conceivable to add both of the “forward packet interpolation method ID” and the “backward packet interpolation method ID” as interpolation method IDs. In this case, an interpolation method ID on the basis of which an interpolation signal for a lost packet is generated can be selected in accordance with any rules.

In a case where the “backward packet interpolation method ID” is used, it is not necessary to wait for arrival of a packet after a loss in order to generate an interpolation signal, so that a delay can be reduced. In a case where the “forward packet interpolation method ID” is used, on the other hand, an interpolation method indicated by an interpolation method ID is selected in consideration of information later than a lost packet, so that a reliable interpolation method can be employed.

### 5. Modifications

Although embodiments of the present technology have been described above, the present technology is not limited to the above-described specific examples, and configurations as various modifications can be employed.

For example, although a configuration in which a tactile signal indicating tactile information sensed by the tactile sensor 3 is input to the transmission device (1 or 1C) and tactile presentation is performed on the reception side on the basis of the tactile signal transmitted by the transmission device has been described in the first, second, and fourth embodiments, a configuration in which a tactile signal stored in a predetermined storage medium is input to the transmission device and tactile presentation is performed on the reception side on the basis of the tactile signal transmitted by the transmission device may be employed, instead.

Furthermore, although an example in which the tactile sensor 3 is separated from the transmission device (1 or 1C) has been described in the above description, a configuration in which the tactile sensor 3 is integrated with the transmission device is also conceivable.

Furthermore, it is also conceivable to employ a configuration in which the tactile presentation device 4 is integrated with a reception device (2, 2A, or 2C).

### 6. Summary of Embodiments

As described above, a first signal processing device (the reception device 2, 2A, or 2C or the tactile presentation device 4B) as an embodiment includes an interpolation signal generation unit (the same F1, F1A, F1B, or F1C) that generates, as an interpolation signal that interpolates a tactile signal lost during transmission, an interpolation signal based on a tactile signal in an adjacent section of a loss section and a physical model or a human perception model related to tactile sensation.

As a result, an interpolation signal based on characteristics related to tactile sensation is generated as the interpolation signal for the loss section of the tactile signal.

It is therefore possible to make it difficult for the user to notice a loss of a tactile signal, and it is possible to improve the user's sense of immersion in tactile content.

Furthermore, in the first signal processing device (the reception device 2 or 2C) as the embodiment, the interpolation signal generation unit (the same F1 or F1C) generates an interpolation signal based on the damped sine wave model as the generation of an interpolation signal based on the physical model.

A damped sine wave is frequently observed in a tactile signal as a vibration waveform due to, for example, a collision or a slip between objects.

By generating an interpolation signal based on the damped sine wave model, therefore, it is possible to make it difficult for the user to notice a loss of a tactile signal, and it is possible to improve the user's sense of immersion in tactile content.

Moreover, in the first signal processing device (the reception device 2A or 2C) as the embodiment, the interpolation signal generation unit (the same F1A or F1C) generates an interpolation signal based on subjective tactile intensity of a tactile signal in an adjacent section as the generation of an interpolation signal based on the perception model.

As a result, it is possible to interpolate the tactile signal in the loss section on the basis of the subjective tactile intensity, which is a main factor in a case where a person discriminates between different tactile stimuli.

It is therefore possible to make it difficult for the user to notice a loss of a tactile signal, and it is possible to improve the user's sense of immersion in tactile content.

Furthermore, in the first signal processing device (the reception device 2A or 2C) as the embodiment, the interpolation signal generation unit (the same F1A or F1C) generates an interpolation signal based on an envelope shape of a tactile signal in an adjacent section as the generation of an interpolation signal based on the perception model.

As a result, it is possible to interpolate the tactile signal in the loss section on the basis of the envelope shape, which is a main factor in a case where a person discriminates between different tactile stimuli.

It is therefore possible to make it difficult for the user to notice a loss of a tactile signal, and it is possible to improve the user's sense of immersion in tactile content.

Furthermore, in the first signal processing device (the reception device 2A or 2C) as the embodiment, the interpolation signal generation unit (the same F1A or F1C) generates an interpolation signal by linearly interpolating at least subjective tactile intensity or an envelope shape of a tactile signal in an adjacent section.

As a result, it is possible to generate an interpolation signal such that the subjective tactile intensity and the envelope shape continuously change with respect to the adjacent section, and as a result, it is possible to make it difficult for the user to notice a loss of the tactile signal, and it is possible to improve the user's sense of immersion in tactile content.

Moreover, in the first signal processing device (the tactile presentation device 4B) as the embodiment, the interpolation signal generation unit (the same F1B) generates an interpolation signal based on an interlocking characteristic between motion and vibration as the generation of an interpolation signal based on the physical model.

As a result, it is possible to appropriately generate an interpolation signal from a motion signal corresponding to a loss section in a case where tactile presentation is performed to the user using a tactile signal interlocked with a motion signal indicating a motion of the user.

It is therefore possible to make it difficult for the user to notice a loss of a tactile signal, and it is possible to improve the user's sense of immersion in tactile content.

Furthermore, in the first signal processing device (the reception device 2C) as the embodiment, the interpolation signal generation unit (the same F1C) selects the interpolation method for a tactile signal on the basis of additional information added to the tactile signal.

This makes it possible to generate an interpolation signal for a loss section by an appropriate interpolation method set in advance before transmission of a tactile signal.

It is therefore possible to make it difficult for the user to notice a loss of a tactile signal, and it is possible to improve the user's sense of immersion in tactile content.

Furthermore, in the first signal processing device as the embodiment, additional information is added for each of unit sections of a tactile signal, and the interpolation signal generation unit (the same F1C) selects an interpolation technique for the tactile signal on the basis of the additional information in a unit section adjacent to a loss section.

This makes it possible to select an appropriate interpolation method corresponding to a loss section in a case where an appropriate interpolation method differs depending on a section of a tactile signal in which the signal is lost.

It is therefore possible to make it difficult for the user to notice a loss of a tactile signal, and it is possible to improve the user's sense of immersion in tactile content.

Furthermore, a first signal processing method as the embodiment is a signal processing method in which a signal processing device generates, as an interpolation signal that interpolates a tactile signal lost during transmission, an interpolation signal based on a tactile signal in an adjacent section of a loss section and a physical model or a human perception model related to tactile sensation.

With such a signal processing method, it is possible to achieve functions and effects similar to those of the first signal processing device as an embodiment.

A second signal processing device (transmission device 1C) as another embodiment includes: an interpolation method selection unit (F5) that selects an interpolation method for interpolating a tactile signal that has been lost during transmission, as signal analysis of the tactile signal, on the basis of a result of performing signal analysis based on a physical model related to tactile sensation or a human perception model; and an interpolation method setting unit (F6) that performs processing so as to generate transmission data in which additional information indicating an interpolation method selected by the interpolation method selection unit is added to the tactile signal, as transmission data of the tactile signal.

With the above configuration, interpolation processing for interpolating a tactile signal lost during transmission can be performed by an appropriate method selected on the basis of a physical model or a human perception model related to tactile sensation.

It is therefore possible to make it difficult for the user to notice a loss of a tactile signal, and it is possible to improve the user's sense of immersion in tactile content.

Furthermore, in the first signal processing device as the embodiment, the interpolation method selection unit performs a signal analysis based on a damped sine wave model as the signal analysis based on the physical model (see FIG. 17).

As a result, it is possible to appropriately determine whether or not the interpolation method based on the damped sine wave model should be selected in a case where the interpolation method based on the damped sine wave model is included as one of selection candidates of the interpolation method.

Processing for interpolating a tactile signal, therefore, can be performed by an appropriate interpolation method, a loss of a tactile signal can be made difficult for the user to notice, and it is possible to improve the user's sense of immersion in tactile content.

Moreover, in the first signal processing device as the embodiment, the interpolation method selection unit selects an interpolation method on the basis of a result of a determination whether or not energy of the tactile signal in a band of a predetermined frequency or more is greater than or equal to a predetermined threshold (see FIG. 17) as the selection of the interpolation method based on the result of the signal analysis based on the perception model.

As a result, it is possible to appropriately determine whether or not to select the interpolation method based on the human perception model related to tactile sensation in a case where the interpolation method based on the human perception model is included as one of the selection candidates of the interpolation method.

Processing for interpolating a tactile signal, therefore, can be performed by an appropriate interpolation method, a loss of a tactile signal can be made difficult for the user to notice, and it is possible to improve the user's sense of immersion in tactile content.

Furthermore, in the first signal processing device as the embodiment, the interpolation method selection unit selects the interpolation method on the basis of information regarding the amount of delay or the amount of operation in a case where the method is employed.

As a result, it is possible to preferentially select an interpolation method with a small amount of delay or a small amount of operation.

It is therefore possible to improve the user's sense of immersion and reduce a processing load required for the interpolation processing by reducing the amount of delay in tactile reproduction in a case where the interpolation processing is performed for a loss of a signal.

Furthermore, in the first signal processing device as the embodiment, the interpolation method selection unit selects the interpolation method on the basis of information regarding an application for which a tactile signal is used.

As a result, it is possible to select and set an appropriate interpolation method in a case where an interpolation method applicable only for a specific application is included as one of the selection candidates, such as a case where interpolation processing can be performed by an interpolation method based on an interlocking characteristic between motion and vibration in a case of an application that performs tactile presentation in accordance with a motion of the user.

It is therefore possible to make it difficult for the user to notice a loss of a tactile signal, and it is possible to improve the user's sense of immersion in tactile content.

Moreover, in the first signal processing device as the embodiment, the interpolation method selecting unit selects the interpolation method for each of unit sections by performing a signal analysis using a tactile signal in an adjacent unit section for each unit section of the tactile signal, and the interpolation method setting unit performs processing for generating, as transmission data, transmission data to which additional information indicating an interpolation method selected by the interpolation method selecting unit for each unit section of the tactile signal is added (see FIG. 17).

This makes it possible to select an appropriate interpolation method corresponding to a loss section in a case where an appropriate interpolation method differs depending on a section of a tactile signal in which the signal is lost.

It is therefore possible to make it difficult for the user to notice a loss of a tactile signal, and it is possible to improve the user's sense of immersion in tactile content.

A second signal processing method as another embodiment is a signal processing method performed by a signal processing device, the signal processing method including selecting an interpolation method for interpolating a tactile signal lost during transmission on the basis of a result of performing, as a signal analysis of the tactile signal, a signal analysis based on a physical model or a human perception model related to tactile sensation and performing processing for generating transmission data in which additional information indicating the selected interpolation method is added to the tactile signal as transmission data of the tactile signal.

With such a signal processing method, it is possible to achieve functions and effects similar to those of the second signal processing device as an embodiment.

Here, as another embodiment, it is possible to consider a program causing a computer device such as a CPU to achieve the functions of the interpolation signal generation unit (F1, F1A, F1B, or F1C) described above with reference to FIGS. 6, 9, 13, 18, and the like or the functions of the interpolation method selection unit (F5) and the interpolation method setting unit (F6) described with reference to FIG. 17 and the like.

That is, a first program as the embodiment is a program readable by a computer device and causing the computer device to achieve a function of generating, as an interpolation signal that interpolates a tactile signal lost during transmission, an interpolation signal based on a tactile signal in an adjacent section of a loss section and a physical model or a human perception model related to tactile sensation.

With such a first program, the first signal processing device as the embodiment described above can be achieved.

Furthermore, a second program as another embodiment is a program readable by a computer device and causing the computer device to achieve an interpolation method selection function of selecting an interpolation method for interpolating a tactile signal lost during transmission on the basis of a result of performing, as a signal analysis of the tactile signal, a signal analysis based on a physical model or a human perception model related to tactile sensation and an interpolation method setting function of performing processing for generating transmission data in which additional information indicating the interpolation method selected by the interpolation method selection function is added to the tactile signal as transmission data of the tactile signal. With such a second program, the second signal processing device as the embodiment described above can be achieved.

The first and second programs as described above can be stored in advance in a storage medium built in a device such as a computer device, a ROM in a microcomputer including a CPU, or the like.

Alternatively, the programs may be temporarily or permanently stored (recorded) in a removable storage medium such as a flexible disk, a compact disc read only memory (CD-ROM), a magnet optical (MO) disk, a digital versatile disc (DVD), a Blu-ray disc (registered trademark), a magnetic disk, a semiconductor memory, or a memory card. Such a removable storage medium can be provided as so-called package software.

Furthermore, the first and second programs may be installed from the removable storage medium onto a personal computer or the like, or may be downloaded from a download site over a network such as a local area network (LAN) or the Internet.

Furthermore, the first and second programs can contribute to a wide range of provision of the first and second signal processing devices according to the embodiments. For example, by downloading the programs onto a personal computer, a portable information processing device, a mobile phone, a gaming device, an audio visual (AV) device, or the like, the personal computer or the like can be caused to function as the first and second signal processing devices in the present technology.

Note that the effects described herein are merely examples and not limited, and other effects may also be provided.

### 7. Present Technology

Note that the present technology can have the following configurations.

(1)

A signal processing device including:
an interpolation signal generation unit that generates an interpolation signal based on a tactile signal in an adjacent section of a loss section and a physical model or a human perception model related to tactile sensation as an interpolation signal that interpolates a tactile signal lost during transmission.
   (2)

The signal processing device according to (1), in which
the interpolation signal generation unit generates an interpolation signal based on a damped sine wave model as the generation of the interpolation signal based on the physical model.
   (3)

The signal processing device according to (1), in which
the interpolation signal generation unit generates an interpolation signal based on subjective tactile intensity of the tactile signal in the adjacent section as the generation of the interpolation signal based on the perception model.
   (4)

The signal processing device according to (1) or (3), in which
the interpolation signal generation unit generates an interpolation signal based on an envelope shape of the tactile signal in the adjacent section as the generation of the interpolation signal based on the perception model.
   (5)

The signal processing device according to (3), in which
the interpolation signal generation unit linearly interpolates at least the subjective tactile intensity or an envelope shape of the tactile signal in the adjacent section to generate the interpolation signal.
   (6)

The signal processing device according to (1), in which
the interpolation signal generation unit generates an interpolation signal based on an interlocking characteristic between motion and vibration as the generation of the interpolation signal based on the physical model.
   (7)

The signal processing device according to any one of (1) to (6), in which
the interpolation signal generation unit selects an interpolation method for a tactile signal on the basis of additional information added to the tactile signal.
   (8)

The signal processing device according to (7), in which
the additional information is added for each of unit sections of the tactile signal, and
the interpolation signal generation unit selects the interpolation method for the tactile signal on the basis of the additional information in a unit section adjacent to the loss section.
   (9)

A signal processing method performed by a signal processing device, the signal processing method including:
generating an interpolation signal based on a tactile signal in an adjacent section of a loss section and a physical model or a human perception model related to tactile sensation as an interpolation signal that interpolates a tactile signal lost during transmission.
   (10)

A program readable by a computer device, the program causing the computer device to achieve a function of:
generating an interpolation signal based on a tactile signal in an adjacent section of a loss section and a physical model or a human perception model related to tactile sensation as an interpolation signal that interpolates a tactile signal lost during transmission.
   (11)

A signal processing device including:
an interpolation method selection unit that selects an interpolation method for interpolating a tactile signal lost during transmission on the basis of a result of performing, as a signal analysis of the tactile signal, a signal analysis based on a physical model or a human perception model related to tactile sensation; and
an interpolation method setting unit that performs processing for generating transmission data in which additional information indicating the interpolation method selected by the interpolation method selection unit is added to the tactile signal as transmission data of the tactile signal.
   (12)

The signal processing device according to (11), in which
the interpolation method selection unit performs a signal analysis based on a damped sine wave model as the signal analysis based on the physical model.
   (13)

The signal processing device according to (11) or (12), in which
the interpolation method selection unit selects the interpolation method based on a result of a determination whether or not energy of the tactile signal in a band of a predetermined frequency or more is greater than or equal to a predetermined threshold as the selection of the interpolation method based on the result of the signal analysis based on the perception model.
   (14)

The signal processing device according to any one of (11) to (13), in which
the interpolation method selection unit selects the interpolation method based on information regarding an amount of delay or an amount of operation in a case where the method is employed.
   (15)

The signal processing device according to any one of (11) to (14), in which
the interpolation method selection unit selects the interpolation method on the basis of information regarding an application for which the tactile signal is used.
   (16)

The signal processing device according to any one of (11) to (15), in which
the interpolation method selection unit performs the signal analysis using a tactile signal in an adjacent unit section for each of unit sections of the tactile signal and selects an interpolation method for each unit section, and
the interpolation method setting unit performs processing for generating, as the transmission data, transmission data to which the additional information indicating the interpolation method selected by the interpolation method selection unit is added for each unit section of the tactile signal.
   (17)

A signal processing method performed by a signal processing device, the signal processing method including:
selecting an interpolation method for interpolating a tactile signal lost during transmission on the basis of a result of performing, as a signal analysis of the tactile signal, a signal analysis based on a physical model or a human perception model related to tactile sensation and performing processing for generating transmission data in which additional information indicating the selected interpolation method is added to the tactile signal as transmission data of the tactile signal.
   (18)

A program readable by a computer device, the program including:
an interpolation method selection function of selecting an interpolation method for interpolating a tactile signal lost during transmission on the basis of a result of performing, as a signal analysis of the tactile signal, a signal analysis based on a physical model or a human perception model related to tactile sensation; and
an interpolation method setting function of performing processing for generating transmission data in which additional information indicating the interpolation method selected by the interpolation method selection function is added to the tactile signal as transmission data of the tactile signal.

### REFERENCE SIGNS LIST

100, 100B Tactile presentation system
1, 1C Transmission device
2, 2A, 2C Reception device
3 Tactile sensor
4, 4B Tactile presentation device
5 Tactile presentation unit
NT Network
11 Sensor interface (I/F)
12 Encoding unit
13 Memory unit
14 Communication unit
15, 15C Control unit
21 First communication unit
22 Memory unit
23 Decoding unit
24 Second communication unit
25, 25A, 25B, 25C Control unit
F1, F1A, F1B, F1C Interpolation signal generation unit
41 Communication unit
42 Drive unit
P1, P2, P3 Packet
Fr1, Fr2, Fr3 Frame
U User
43 Motion sensor
6 Presentation control device
61 Communication unit
62 Encoding unit
63 Control unit
63a Tactile signal generation unit
F5 Interpolation method selection unit
F6 Interpolation method setting unit

1. A signal processing device comprising:
an interpolation signal generation unit that generates an interpolation signal based on a tactile signal in an adjacent section of a loss section and a physical model or a human perception model related to tactile sensation as an interpolation signal that interpolates a tactile signal lost during transmission.

2. The signal processing device according to claim 1, wherein
the interpolation signal generation unit generates an interpolation signal based on a damped sine wave model as the generation of the interpolation signal based on the physical model.

3. The signal processing device according to claim 1, wherein
the interpolation signal generation unit generates an interpolation signal based on subjective tactile intensity of the tactile signal in the adjacent section as the generation of the interpolation signal based on the perception model.

4. The signal processing device according to claim 1, wherein
the interpolation signal generation unit generates an interpolation signal based on an envelope shape of the tactile signal in the adjacent section as the generation of the interpolation signal based on the perception model.

5. The signal processing device according to claim 3, wherein
the interpolation signal generation unit linearly interpolates at least the subjective tactile intensity or an envelope shape of the tactile signal in the adjacent section to generate the interpolation signal.

6. The signal processing device according to claim 1, wherein
the interpolation signal generation unit generates an interpolation signal based on an interlocking characteristic between motion and vibration as the generation of the interpolation signal based on the physical model.

7. The signal processing device according to claim 1, wherein
the interpolation signal generation unit selects an interpolation method for a tactile signal on a basis of additional information added to the tactile signal.

8. The signal processing device according to claim 7, wherein
the additional information is added for each of unit sections of the tactile signal, and
the interpolation signal generation unit selects the interpolation method for the tactile signal on a basis of the additional information in a unit section adjacent to the loss section.

9. A signal processing method performed by a signal processing device, the signal processing method comprising:
generating an interpolation signal based on a tactile signal in an adjacent section of a loss section and a physical model or a human perception model related to tactile sensation as an interpolation signal that interpolates a tactile signal lost during transmission.

10. A program readable by a computer device, the program causing the computer device to achieve a function of:
generating an interpolation signal based on a tactile signal in an adjacent section of a loss section and a physical model or a human perception model related to tactile sensation as an interpolation signal that interpolates a tactile signal lost during transmission.

11. A signal processing device comprising:
an interpolation method selection unit that selects an interpolation method for interpolating a tactile signal lost during transmission on a basis of a result of performing, as a signal analysis of the tactile signal, a signal analysis based on a physical model or a human perception model related to tactile sensation; and
an interpolation method setting unit that performs processing for generating transmission data in which additional information indicating the interpolation method selected by the interpolation method selection unit is added to the tactile signal as transmission data of the tactile signal.

12. The signal processing device according to claim 11, wherein
the interpolation method selection unit performs a signal analysis based on a damped sine wave model as the signal analysis based on the physical model.

13. The signal processing device according to claim 11, wherein
the interpolation method selection unit selects the interpolation method based on a result of a determination whether or not energy of the tactile signal in a band of a predetermined frequency or more is greater than or equal to a predetermined threshold as the selection of the interpolation method based on the result of the signal analysis based on the perception model.

14. The signal processing device according to claim 11, wherein
the interpolation method selection unit selects the interpolation method based on information regarding an amount of delay or an amount of operation in a case where the method is employed.

15. The signal processing device according to claim 11, wherein
the interpolation method selection unit selects the interpolation method on a basis of information regarding an application for which the tactile signal is used.

16. The signal processing device according to claim 11, wherein
the interpolation method selection unit performs the signal analysis using a tactile signal in an adjacent unit section for each of unit sections of the tactile signal and selects an interpolation method for each unit section, and
the interpolation method setting unit performs processing for generating, as the transmission data, transmission data to which the additional information indicating the interpolation method selected by the interpolation method selection unit is added for each unit section of the tactile signal.

17. A signal processing method performed by a signal processing device, the signal processing method comprising:
selecting an interpolation method for interpolating a tactile signal lost during transmission on a basis of a result of performing, as a signal analysis of the tactile signal, a signal analysis based on a physical model or a human perception model related to tactile sensation and performing processing for generating transmission data in which additional information indicating the selected interpolation method is added to the tactile signal as transmission data of the tactile signal.

18. A program readable by a computer device, the program comprising:
an interpolation method selection function of selecting an interpolation method for interpolating a tactile signal lost during transmission on a basis of a result of performing, as a signal analysis of the tactile signal, a signal analysis based on a physical model or a human perception model related to tactile sensation; and
an interpolation method setting function of performing processing for generating transmission data in which additional information indicating the interpolation method selected by the interpolation method selection function is added to the tactile signal as transmission data of the tactile signal.
